(19) United States
(12) Patent Application Publication
(10) Pub. No.: US 2015/0081350 A1
(43) Pub. Date: Mar. 19, 2015

(54) MOBILE ONLINE VACATION RENTAL BOOKING SYSTEM

(71) Applicant: Huan Truong, Corona, CA (US)

(72) Inventor: Huan Truong, Corona, CA (US)

(21) Appl. No.: 14/552,412

(22) Filed: Nov. 24, 2014

Related U.S. Application Data
(63) Continuation-in-part of application No. 14/494,440, filed on Sep. 23, 2014.
Application No. 14/494,440 is a continuation-in-part of application No. 13/940,124, filed on Jul. 11, 2013.

(51) Int. Cl. G06Q 10/02; G06Q 30/06; G06F 17/30; G06Q 50/14

(52) U.S. Cl. CPC G06Q 10/02; G06Q 50/14; G06Q 30/0645; G06F 17/30864
USPC 705/5

(57) ABSTRACT

A mobile online vacation rental booking system, having a mobile application with a selectable user interface, coupled to a mobile device display, and configured to transmit vacation data to the mobile device and receive vacation data from the mobile device. An aggregator search engine is coupled to receive vacation data from the mobile device and to transmit vacation data to the mobile device. Remote partner databases are coupled with the engine to exchange the vacation data. The engine is configured to cause the vacation data to be shown on the display. A method of booking an online vacation rental uses a mobile device to: select a geospatial region; access partner databases with the mobile device to find a vacation rental properties; identify vacation rental properties; explore attractions close to the vacation rental properties; display a property detail of the vacation rental properties; and select one of the vacation rental properties.

### CROSS-REFERENCES TO RELATED APPLICATIONS

This application is a continuation-in-part of U.S. application Ser. No. 13/940,124, filed Jul. 11, 2013 and entitled “ONLINE VACATION RENTAL BOOKING SYSTEM,” and is a continuation-in-part of U.S. application Ser. No. 14/494,440, filed Sep. 23, 2014, and entitled “ONLINE VACATION RENTAL BOOKING SYSTEM,” both of which are assigned to the same assignee hereof, and both of which are incorporated by reference herein in their entirety.

### BACKGROUND OF THE INVENTION

1. Field of Invention

The invention relates generally to booking systems, and more particularly, to an online vacation rental booking system.

2. Description of Related Art

Travel bookings are one of the largest components of e-commerce. Online travel websites help users find and book cheap flights, hotels, vacations, rental cars, bed and breakfasts, cruise lines, etc. Many websites include some sort of search engine technology to look for bookings within a certain timeframe, service class, geographic location, or price range.

One type of travel booking is vacation rentals. A vacation rental is the renting out of a place on a temporary basis to tourists as an alternative to a hotel, motel, or hostel. Vacation rentals are also referred to as vacation homes, villas, townhouses, condominiums, furnished apartments, houses, etc. Vacation rentals have long been a popular lodging option in Europe and Canada, and are increasingly becoming popular across the rest of the world.

Typically, major differences exist between a traveler that is planning to stay in a vacation rental and a traveler that is planning to stay in a hotel. A first major difference is the timing of the planning and stay, affecting the timeframe for the stay. The vacation rental traveler typically plans ahead more, has a longer stay planned, and has a more flexible vacation schedule. For example, if a traveler is just passing through town for one night and looking for lodging, often the most convenient option is a hotel. By contrast, a vacation rental is the best option for a traveler who has several months to plan his vacation from work or school and wants to stay for many days. Vacation rentals are usually less expensive, more spacious, closer to the local non-tourist cultural spots, and often have amenities only found in the more expensive hotels.

Another major difference between vacation rentals and hotels is the size of the lodging desired, affecting the number of bedrooms desired. Often times vacation rentals are better suited for larger groups, such as a family, requiring a specific number of bedrooms. If a single traveler is going on a trip, often the most convenient option is a hotel. By contrast, a person traveling with his family, pets, or a large group, often the best option is a vacation rental. Vacation rentals are more likely to feel like a home away from home. Vacation rentals can have many bedrooms and high end amenities such as a private pool or kitchen.

A problem with conventional vacation rental bookings is that it is challenging for a traveler having flexibility in travel times but not in the size of his group. Often times, the vacation rental traveler will plan his vacation several months in advance, look for which city or country to visit, look for which month to travel, and look for places that accommodate his entire family. When a traveler is planning his vacation from work or during summer break, often times he has a group size and trip length that makes hotel stays undesirable.

Conventional booking systems exist to book travel online. For example, U.S. Pat. Pub. No. 2010/0293011 to Lebreton is directed to a method of generating an offer for resources, such as a hotel room, which meets a customer request and satisfies at least one customer preference. In one embodiment, Lebreton illustrates a table having a one day period of time in the six columns (i.e., January 1st thru 6th) and six different hotels in the six rows (i.e., hotel 1, hotel 2, hotel 3, hotel 4, hotel 5, and hotel 6). Each cell within the table shows the hotel's availability and price for that specific day. This enables the traveler to see if one hotel, or a mixture of hotels, is available for the entire stay.

However, Lebreton falls short in that it does not help a traveler who has flexibility in terms of which month to travel, which city to travel to, and is looking for a specific or minimum number of bedrooms.

### SUMMARY OF THE INVENTION

Embodiments of the invention provide a Mobile Online Vacation Rental Booking System having a mobile application with a selectable user interface coupled to a display of a mobile device, the selectable user interface configured to transmit first selected vacation data to the mobile device and receive second selected vacation data from the mobile device. The embodiment also includes an aggregator search engine coupled to receive first selected vacation data from the mobile device and to transmit second selected vacation data to the mobile device, and a plurality of remote partner databases coupled with the aggregator search engine to exchange the first selected vacation data for second selected vacation data. The aggregator search engine is configured to cause the second selected vacation data to be shown on the display. In the embodiment, the aggregator search engine is wirelessly coupled to receive first selected vacation data from the mobile device. The mobile device can be coupled to the aggregator search engine using one of Bluetooth®, IEEE 802.11, IEEE 802.15, IEEE 802.16, IEEE 802.20, GSM/GPRS/EDGE, CEMA/WCDMA/CDMA-2000, LTE, or TDMA/PDC.

In the embodiment, the selectable user interface can include a SEARCH module and one of the plurality of remote partner databases includes a vacation rental database. The first selected vacation data can be a location for a selected vacation rental property, and the second selected vacation data can be a record corresponding to the selected vacation rental property. The first selected vacation data can further include check in/out time, accommodation, or both. Also, the selectable user interface can include an EXPLORE module and one of the plurality of remote partner databases includes an attraction database. In this case, the first selected vacation data includes one of categories of attractions and the second selected vacation data comprises a selected attraction having second selected attributes and an interactive map relative to a geospatial location. When the selectable user interface is selected to include an EXPLORE module, the first selected vacation data is changed to one of categories of attraction and the second selected vacation data is changed to selected attractions having second selected attributes and an interactive map relative to a geospatial location.

In addition, the selectable user interface can be selected to include a BOOK module coupled to a vacation rental property of one of a plurality of remote partner databases, the first selected vacation data can be booking information for the vacation rental property and the second selected vacation data can be one of a confirmation of booking a specific vacation rental property of a geospatial location, or a decline, or a “contact owner” message.

In another system embodiment, there is provided a mobile online vacation rental booking system having a selectable user interface including a BOOK module coupled to a display of a mobile device, the selectable user interface on the display configured to transmit first selected vacation data to and receive second selected vacation data from the mobile device, an aggregator search engine wirelessly coupled to the mobile device, the aggregator search engine configured to receive first selected vacation data from and transmit second selected vacation data to the mobile device, and one of a plurality of remote partner databases coupled with the aggregator search engine, the one configured to receive first selected vacation data from and to transmit second selected vacation data to the aggregator search engine, the one further configured to book a selected vacation rental property associated with the one upon receiving booking information as the first selected vacation data and to transmit one of a confirmation of a specific rental at a geospatial location, or a decline, or a “contact owner” message as second selected vacation data.

In an alternative system, there is included a selectable user interface including an ASK module coupled to a display of a mobile device, an aggregator search engine wirelessly coupled to the mobile device, the aggregator search engine configured to receive a selected query from and transmit a corresponding response to the mobile device, and a response mechanism configured to produce the corresponding response in response to the selected query. In another embodiment, the system includes a selectable user interface including a CONCIERGE module coupled to a display of a mobile device, the selectable user interface on the display configured to transmit first selected vacation data to and receive second selected vacation data from a system intermediary, wherein the first selected vacation data is a reservation or an engagement of a service and the second selected vacation data is a confirmation of the reservation or the engagement.

In yet another embodiment, the system includes a selectable user interface including an EXPLORE module coupled to a display of a mobile device, the selectable user interface on the display configured to transmit first selected vacation data to and receive second selected vacation data, wherein the first selected vacation data includes a selected category of attraction and a selected attraction and the second selected vacation data includes an interactive map corresponding the selected attraction.

A method of booking a mobile online vacation rental is also embodied, including, with a mobile device, selecting a geospatial region, accessing a plurality of partner databases with the mobile device to find a vacation rental properties at the geospatial region, identifying vacation rental properties proximate to a selected geospatial location in the geospatial region, generating identified vacation rental properties, exploring attractions proximate to the identified vacation rental properties, displaying a property detail of the identified vacation rental properties; and selecting one of the vacation rental properties based on an attraction or the property detail or both.

The method further can include selecting between a hotel or a property rental before selecting a geospatial location. Also, after selecting the one of the vacation rental properties, booking the selected vacation property with the mobile device, placing a deposit on the one of the vacation rental properties with the mobile device, and receiving a confirmation or a decline from the vacation property manager to the mobile device. Prior to displaying the property detail with the mobile device, the method can include sorting the identified vacation rental properties according to price or distance.

Alternatively, prior to displaying the property detail with the mobile device, the method can include filtering the identified vacation rental properties according to location type, property type, or price. Another alternative can include activating a CONCIERGE module, selecting a service category in the CONCIERGE module, and engaging a listed service or listed activity, or fulfilling an inquiry, corresponding to the service category.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a monthly grid view of a system according to an embodiment of the invention;

FIG. 2 illustrates a weekly grid view of the system according to an embodiment of the invention;

FIG. 3 illustrates a drilling feature of the system according to an embodiment of the invention;

FIG. 4 illustrates a day matching feature of the system according to an embodiment of the invention;

FIG. 5 illustrates the process of using the system according to an embodiment of the invention;

FIG. 6 illustrates a online vacation rental system disposed according to an embodiment of the invention;

FIG. 7 is an interactive entry matrix according to an embodiment of the invention;

FIG. 8 illustrates an interactive period grid including coupled, color-coded, interactive cells according to an embodiment of the invention;

FIG. 9 illustrates an interactive, coded seasonal grid according to an embodiment of the invention;

FIG. 10 illustrates a property matrix according to an embodiment of the invention;

FIG. 11 is a mapping from a property matrix element to an interactive property record according to an embodiment of the invention;

FIG. 12 is a representation of an a property record and related interactive graphical mappings according to an embodiment of the invention;

FIG. 13A is a graphical representation of a mobile online vacation rental booking system, in accordance with the teachings of the present invention;

FIG. 13B is a graphical representation of a mobile online vacation rental booking system having functional modules, in accordance with the teachings of the present invention;

FIG. 14 is a graphical representation of a mobile online vacation rental booking system having a SEARCH module, in accordance with the teachings of the present invention;

FIG. 15 is a graphical representation of a mobile online vacation rental booking system having an EXPLORE module, in accordance with the teachings of the present invention;

FIG. 16 is a graphical representation of a mobile online vacation rental booking system having an BOOK module, in accordance with the teachings of the present invention;

FIG. 17 is a graphical representation of a mobile online vacation rental booking system having an ASK module, in accordance with the teachings of the present invention; and

FIG. 18 is a graphical representation of a mobile online vacation rental booking system having a CONCIERGE module, in accordance with the teachings of the present invention.

### DETAILED DESCRIPTION OF EMBODIMENTS

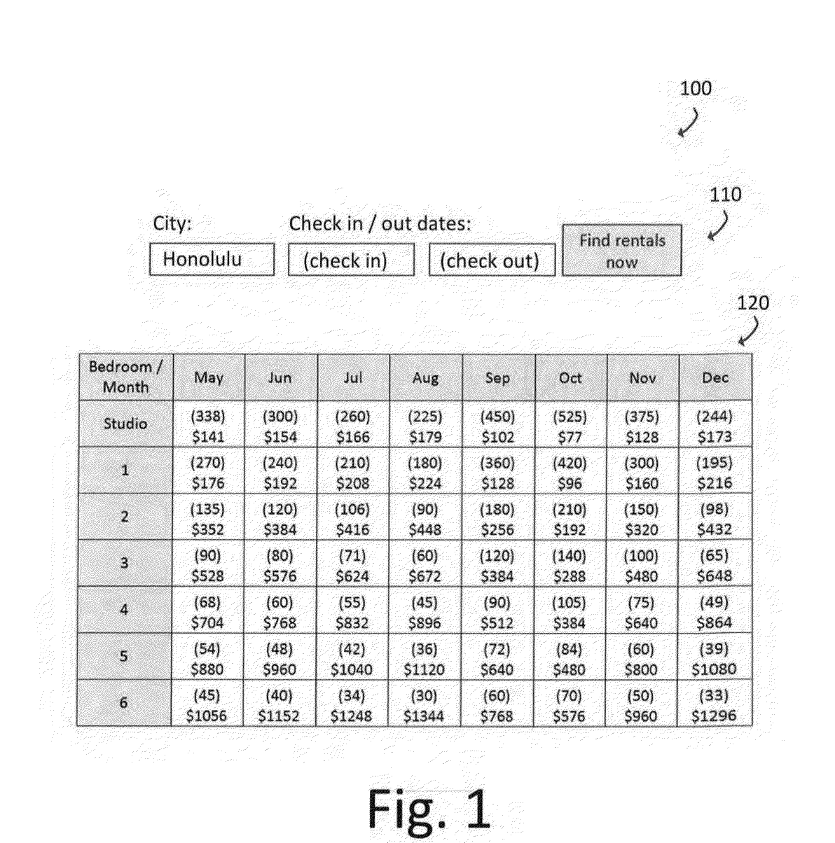

Further features and advantages of the invention, as well as the structure and operation of various embodiments of the invention, are described in detail below with reference to the accompanying FIGS. 1-18, wherein like reference numerals refer to like elements.

The present invention provides, in at least one embodiment, an intelligent search engine for vacation rentals to output to a mobile device. In one embodiment, a method and system aggregates rental properties and provides rental availability and its nightly average rate for a vacation rental search engine. The search result is displayed via graphical grid interface that includes a monthly/weekly timeline at the horizontal axis and bedroom sizes at the vertical axis. Available units and average nightly rates are display within each cell grid.

FIG. 1 illustrates a monthly grid view of a system 100 according to an embodiment of the invention. The system 100 includes a search engine 110 and a grid of cells 120. The system 100 provides a more convenient and flexible way to search for and book vacation rentals on line.

The search engine 110 allows a traveler to search based on location and time. As illustrated, the search engine 110 provides a field for a city, fields for check in and check out dates, and a search button to find rentals now. The search engine searches a vacation rental database based on the desired location and time frame. One with skill in the art could design a different arrangement for the search engine 110 without departing from the scope of the invention. For example, the location could be a field for a zip code, county, state, country, etc.

The grid of cells 120 (e.g., monthly grid view, initial plurality of cells, etc.) displays a monthly grid view of the vacation rentals in the desired location (e.g., Honolulu) and months surrounding the desired check in and check out dates. Each of the cells is based on a number of bedrooms in a particular row and a month in a particular column.

For example, the cell in the upper left hand corner indicates that there are 338 Honolulu studios available sometime during the month of May, and the average nightly price of these available studios is $141. If the traveler is willing to delay his vacation until a non-summer month, such as October, the selection increases to 525 available studios and the average nightly price drops down to $77. As such, at a glance, a traveler can conveniently see the availability and prices for different months and bedrooms.

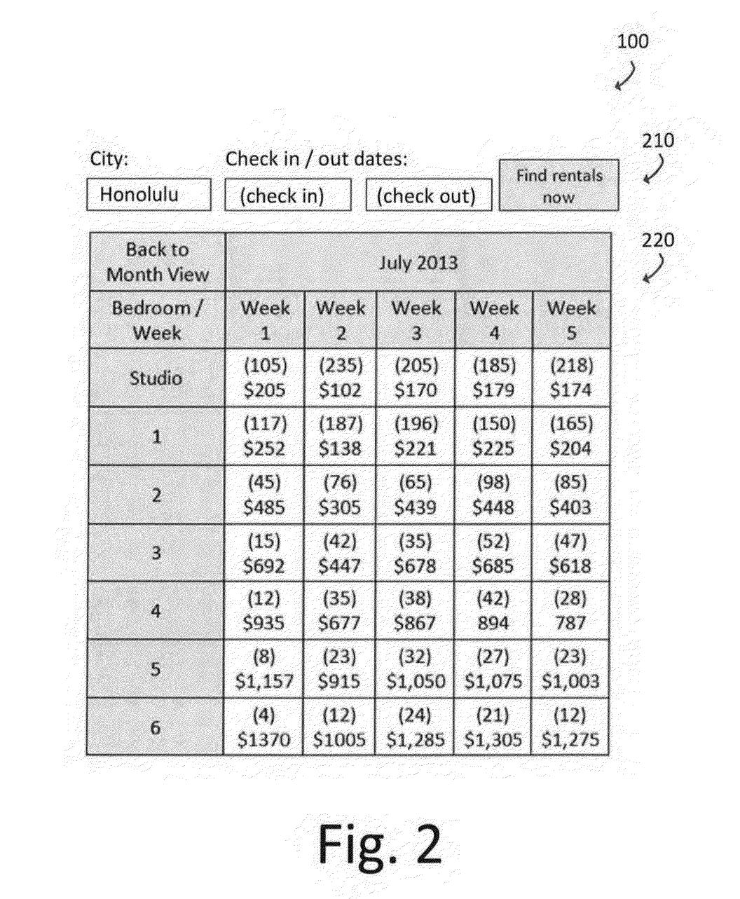

FIG. 2 illustrates a weekly grid view of the system 100 according to an embodiment of the invention. The system 100 includes a search engine 210 and a grid of cells 220. The search engine 210 can be the same as the search engine 110 described in Fig. I. The system 100 can also include individual listings (not shown) of the vacation rentals available for the desired city and a profile picture for each.

The grid of cells 220 (e.g., weekly grid view, subsequent plurality of cells, etc.) provide a weekly display of the rentals in the desired location (e.g., Honolulu) and the weeks surrounding the desired check in and check out dates. Each cell is based on a number of bedrooms in that particular row and based on a week in that particular column.

For example, the cell in the upper left hand corner indicates that there are 105 Honolulu studios available sometime during the first week of July, and the average nightly price during the first week is $205. If the traveler is willing to delay his vacation until after the 4th of July, the second week of July has significantly more availability and lower prices, both of which may be desirable to a flexible traveler.

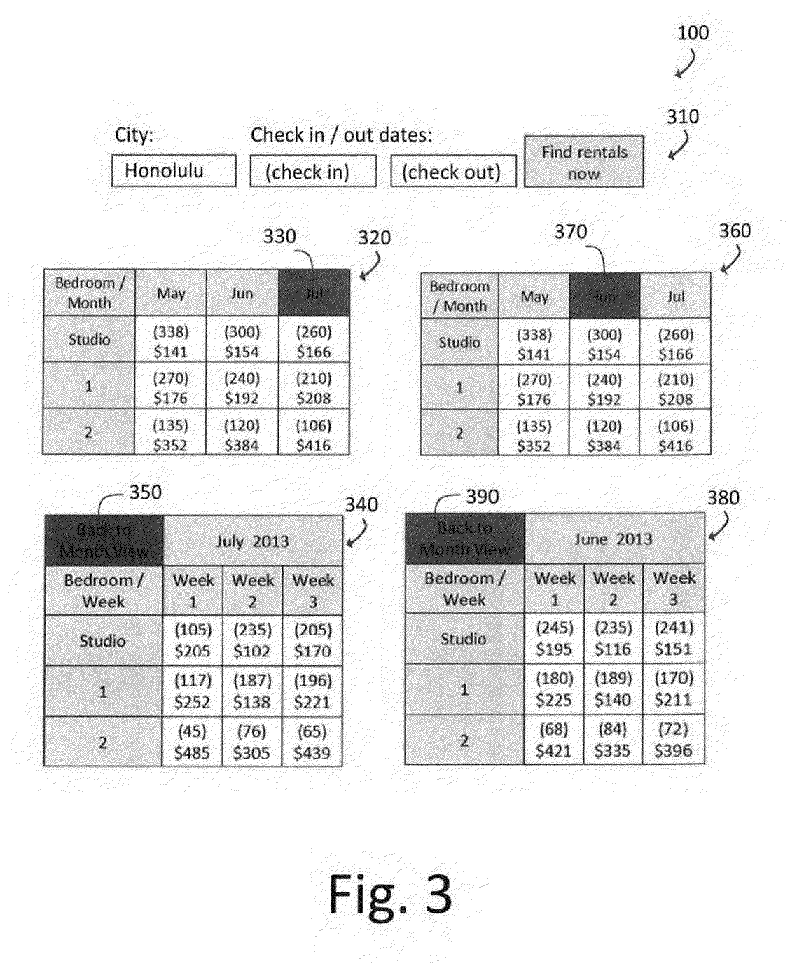

FIG. 3 illustrates a drilling feature of the system 100 according to an embodiment of the invention. The system 100 has a search engine 310 (like the search engine 110), a first grid of cells 320, a second grid of cells 340, a third grid of cells 360, and a fourth grid of cells 380. Each of the grid of cells 320, 340, 360, 380 illustrate only a limited number of months, weeks, and bedrooms to more clearly focus on the drilling down and up feature. The system 100 has a drilling down and up feature that allows the traveler to go back and forth between monthly and weekly grids views.

The first grid of cells 320 displays three bedroom options over three months. To drill down, a first selection 330 selects the month of July. In another embodiment, the first selection 330 selects any of the four cells in this column to drill down to the weeks in July. The first selection 330 drills down from the month based view 320 to the week based view 340.

The second grid of cells 340 displays three bedroom options over the first three weeks of July. To drill back up, a second selection 350 takes the traveler back to the month based view 360. One with skill in the art could design a different arrangement for going back and forth between two web pages without departing from the scope of the invention. For example, the traveler could use a browser's back button.

The third grid of cells 360 shows the same data as the first grid of cells 320. Similar to the first selection 330, to drill down again, the third selection 370 selects the month of June, drills down from the month based view 360 to the week based view 380.

The fourth grid of cells 380 displays three bedroom options over the first three weeks of June. Similar to the second selection 350, to drill up again, the fourth selection 390 takes the traveler back to the month based view 360.

This drilling feature advantageously allows a traveler to quickly and easily view vacation rentals based on different periods of time. The traveler can drill down from a particular month to a particular week, or vice a versa, to view the availability and prices for that period of time.

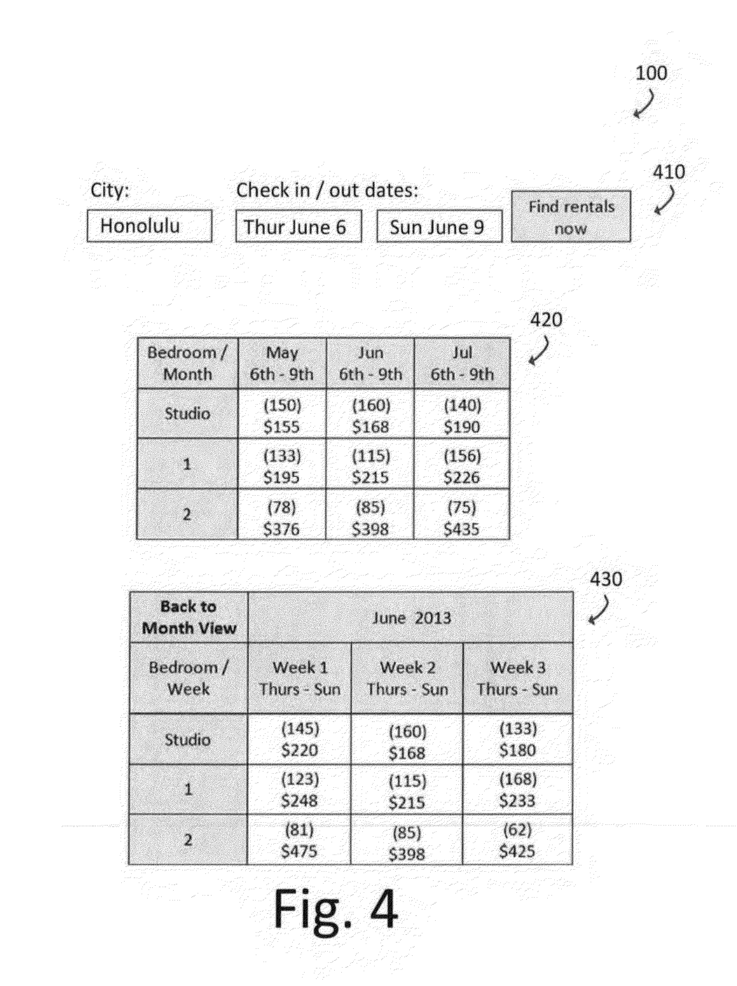

FIG. 4 illustrates a day matching feature of the system 100 according to an embodiment of the invention. The system 100 has a search engine 410 (like the search engine 110), a monthly grid of cells 420 and a weekly grid of cells 430. Each grid of cells 420 and 430 illustrate only a limited number of months, weeks, and bedrooms to more clearly focus on the day matching feature.

The system 100 illustrates the day matching feature to match days of a month (e.g., 6th through 9th) between several months in the monthly grid view and days of a week (e.g., Thursday through Sunday) between several weeks in the weekly grid view.

The monthly grid of cells 420 displays three bedroom options over three months. In this example, the desired stay is from Thursday, June 6th through Sunday, June 9th. As such, the day matching feature allows each column to maintain the desired days per month (the 6th-9th) in the monthly grid view 420. The availability and prices refer only to the desired days of the month. If the traveler drills down to the weeks of June, the weekly grid of cells 430 displays three bedroom options over three weeks. Again, the availability and prices refer only to the days of the week desired (e.g., Thursday through Sunday).

In one embodiment, the availability and price include only places that have availability over the entire check-in/check-out range. In another embodiment, the availability and price include only places that have availability over less than the entire check in/out range.

This matching feature is beneficial for a person who typically vacations on certain times of month (e.g., first week of the month) or on certain days per week (e.g., Thursday through Sunday). By matching the days, the traveler gets an “apples-to-apples” comparison of the average nightly prices of different months or weeks.

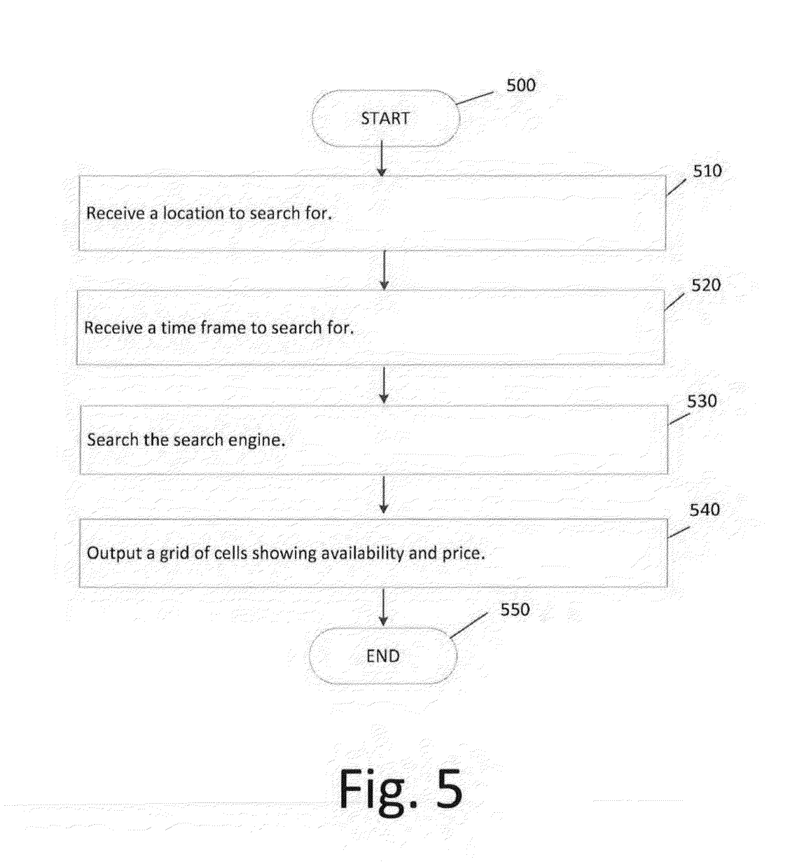

FIG. 5 illustrates the process of using the system 100 according to an embodiment of the invention. The process starts at step 500. At step 510, the system 100 receives a location to search for. In one embodiment, the system 100 is configured to receive any major city in the world. At step 520, the system 100 receives a time frame to search for. In one embodiment, the time frame is the travelers desired travel dates. The traveler hits the search button and the system searches the search engine 110 at step 530. At step 540, the system 100 outputs a grid of cells showing the availability and price based on a period of time and a number of bedrooms. The grid of cells can be a monthly grid 120 or a weekly grid 220. The process may be repeated recursively a number of times and ends at step 550.

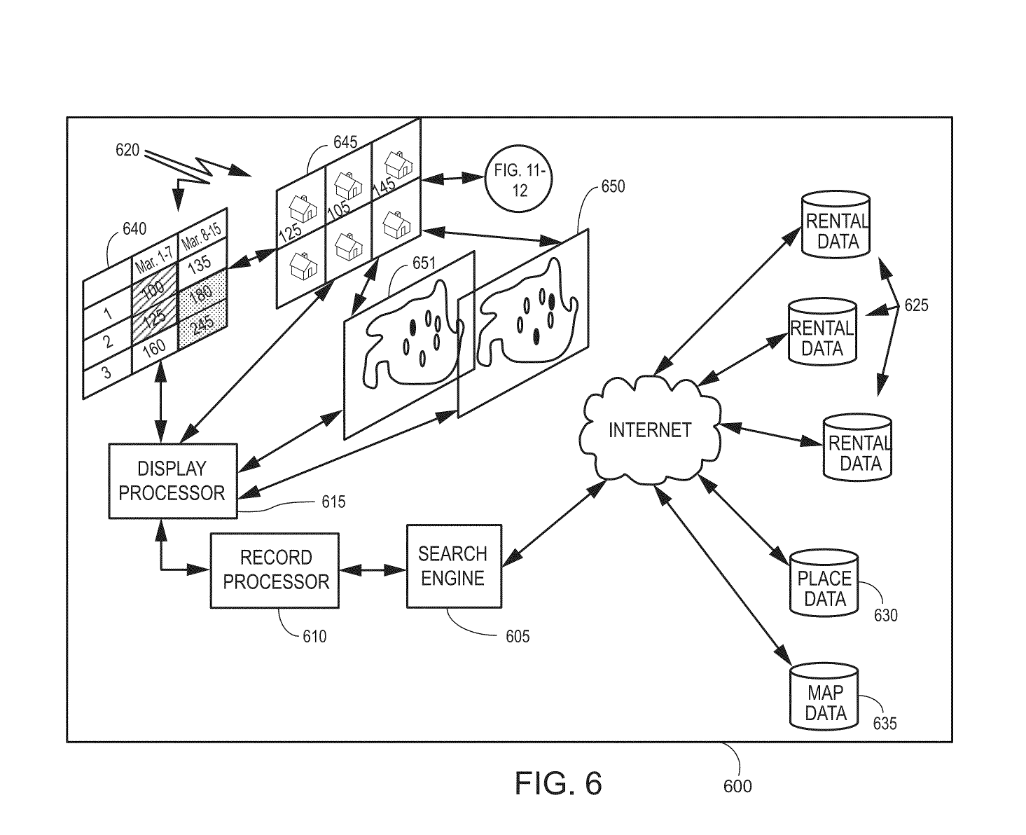

FIG. 6 is a graphical depiction of an embodiment of an online vacation rental system 600. System 600 includes a search engine 605, record processor 610, display processor 615, and interactive graphical user interface 620, which together searches, identifies, selects, and displays vacation rental system records to a user (not shown) of system 600. Search engine 605 can be a hospitality search engine coupled to vacation rental databases, generally at 625, which may be provided by one or more property vendors. Search engine 605 also may be coupled to a property mapping database 630, and maybe a spatial map database containing interactive geospatial mapping 636 ability for areas surrounding and including selected vacation rental properties. Attraction database 635 allows geospatial mapping 638 of featured places, such as, without limitation, dining and drinking establishments, which may be in proximity to selected vacation rental properties. A ratings and recommendation database 634 may also be employed, in which the ratings and recommendations may correspond to the featured places in mapping 638. Access to such a database, which may be a YELP® database, may be implemented using YELP® API, available at http://www.yelp.com/developers/documentation, from YELP®, San Francisco, Calif.

Information pertaining to vacation rental properties is contained in vacation rental properties records which, after selection by search engine 605, are processed by record processor 610. Record processor 610 can provide information regarding one or more vacation rental properties, and may provide all or part of vacation rental properties records depending upon the context of presentation.

Vacation rental properties records include multiple records pertaining to the corresponding vacation rental property including, without limitation, vacation rental property identification, vacation rental property type, vacation rental property location, vacation rental property number of bedrooms, number of guests that can be lodged at the property, number of bathrooms, average nightly booking rate on a specific day or range of dates, and narratives information regarding the ambience, amenities, or both corresponding to the property. Record processor 610, for example, can be capable of determining average nightly booking rates for a single vacation rental property or over a plurality of selected vacation rental properties records. In certain embodiments, search engine 605 finds a plurality of records matching preselected criteria, and records processor 610 determines the average nightly booking rate for a type of accommodation, such as number of rooms, over preselected time periods, such as one or more selected weekly or monthly time periods.

Other records, such as featured place and spatial information records, can be processed by record processor 610, which may color code selected featured place and spatial information records to assist the user (not shown) in comprehending the information at-a-glance. Display processor 615, collects the records provided by records processor 610 and interactively couples them to interactive graphical user interface (GUI) 620, where the user (not shown) may view, understand, select, or manage the data records provided by records processor 610. Display processor 615 can be adapted to display one or more records in grid or matrix form. GUI 620 may include coupled, color-coded, interactive price grid 640, interactive property matrix 645, or one or more interactive maps 650, 651.

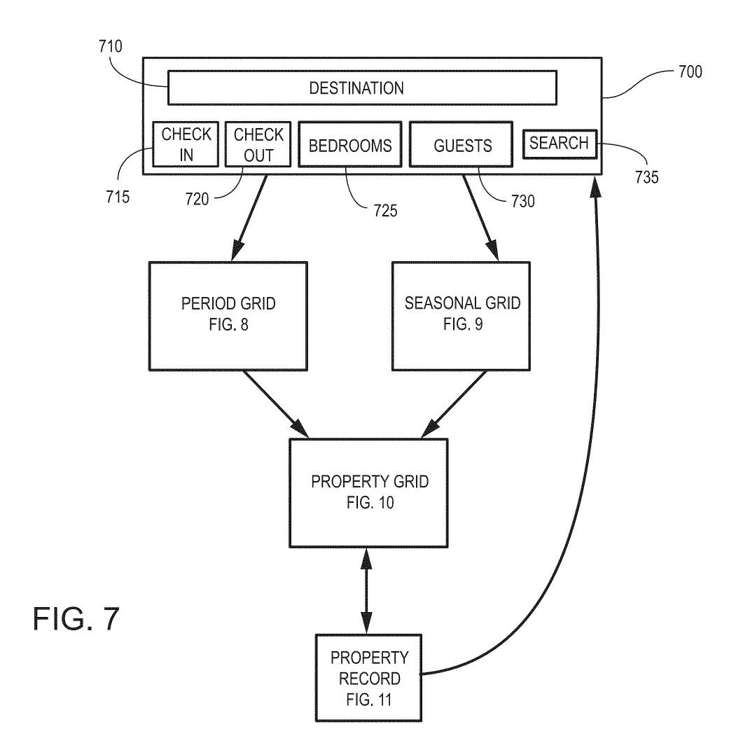

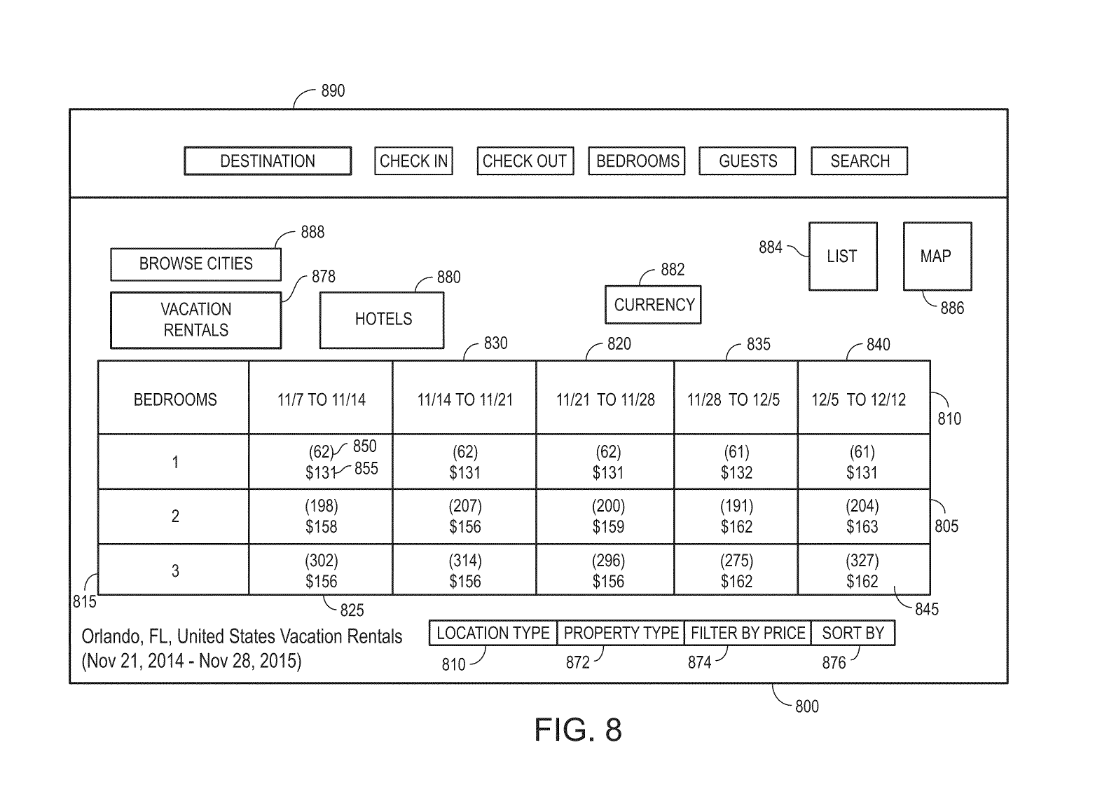

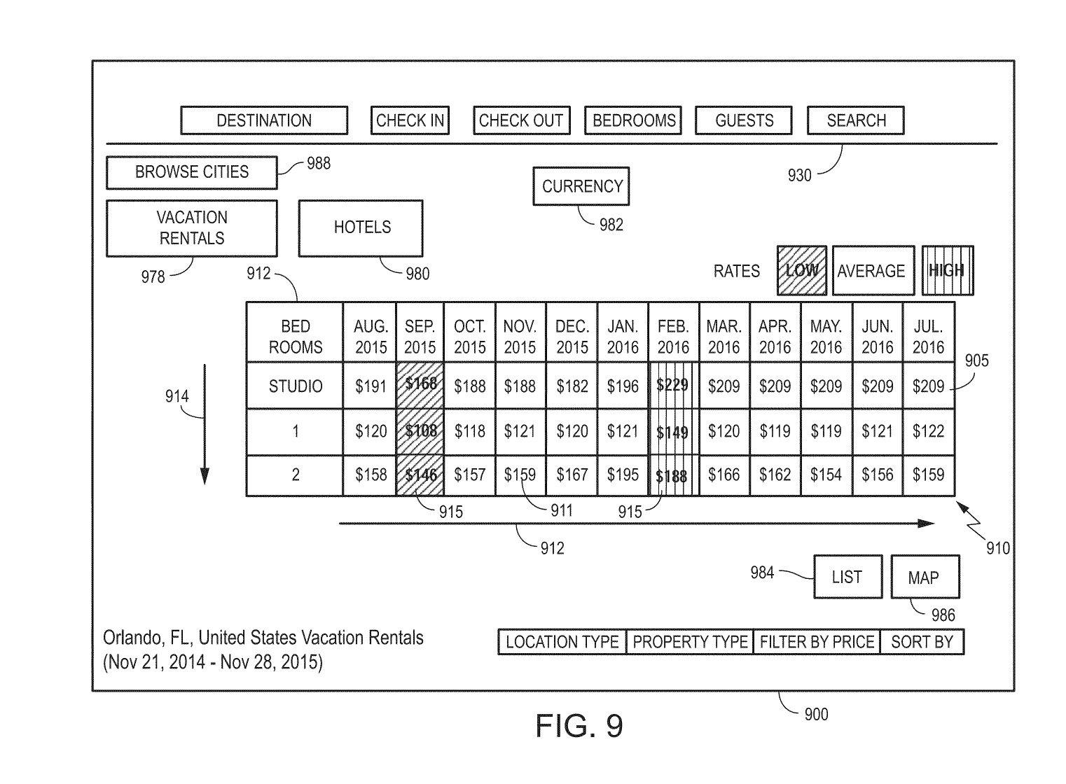

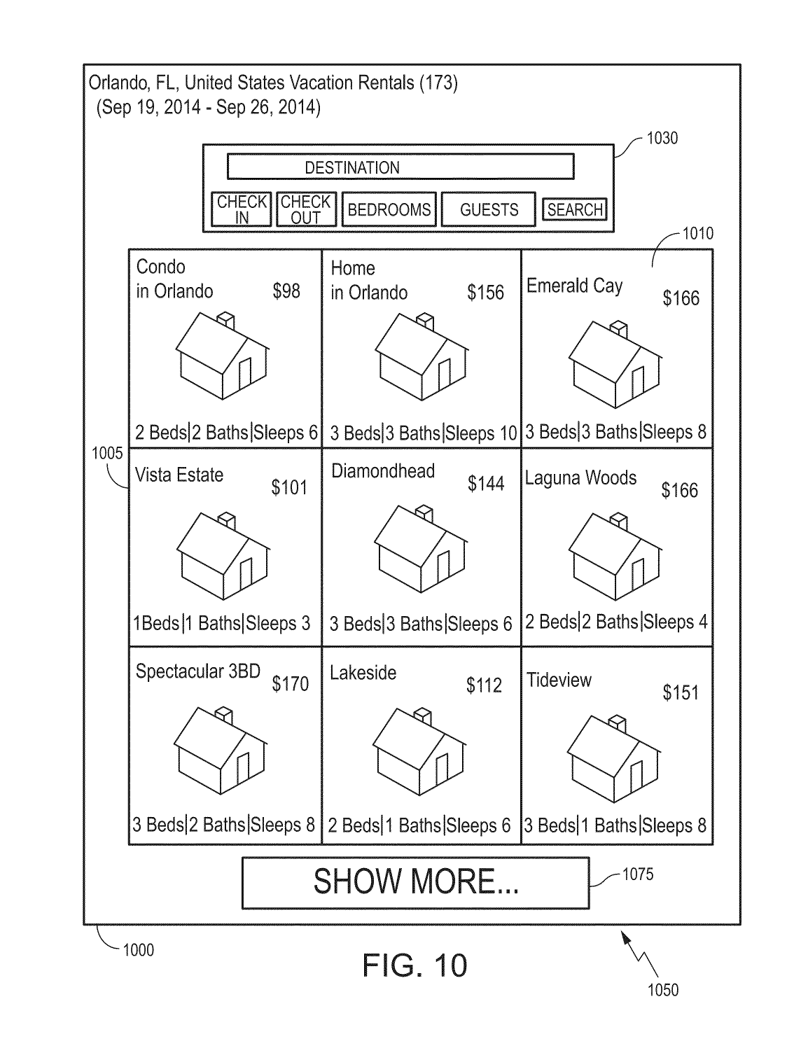

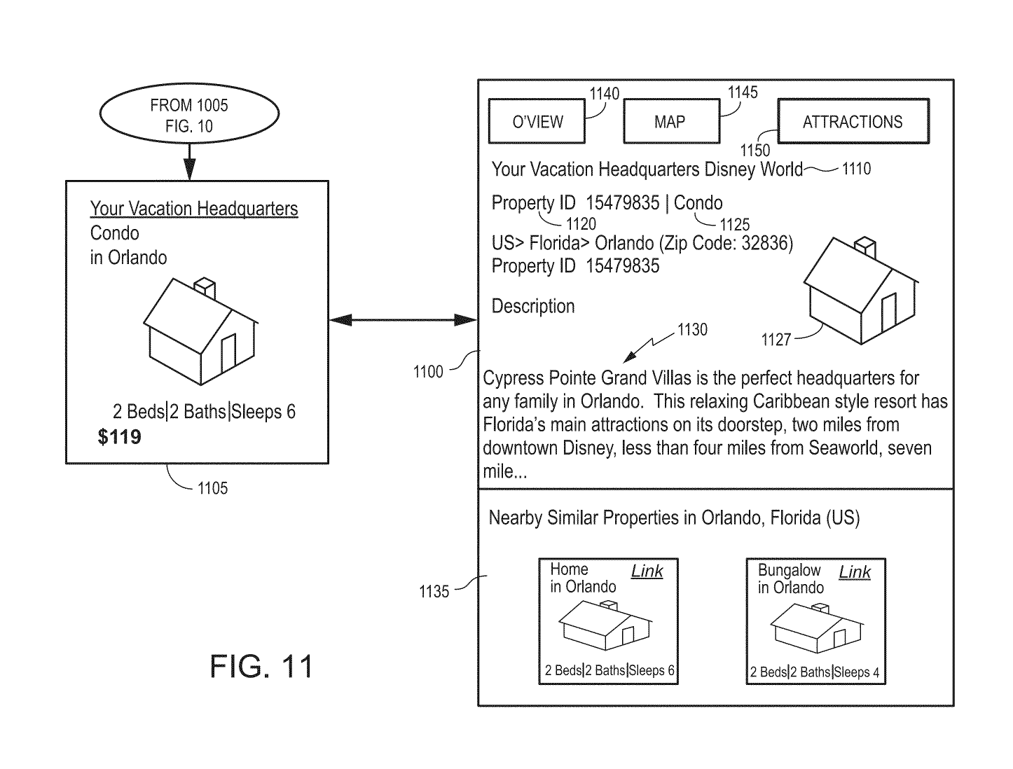

FIG. 7 illustrates one embodiment of a vacation data entry matrix 700, which is one way to enter an embodiment of an online vacation rental booking system. Matrix 700 can include an element of interaction in a graphical user interface element (widget) 710 disposed to receive vacation destination data; a check-in widget 715, which may be disposed as a selectable calendar for selecting potential check in date data; a check-out widget 720, which may be disposed as a selectable calendar for selecting potential check out date data; a bedroom widget 725, which may implemented as a drop down menu, disposed to receive data representing the number of bedrooms sought by the prospective vacationer in a vacation property; a guest widget 730, which may implemented as a drop down menu, disposed to receive data representing the number of guests sought to be lodged in a vacation property by the prospective vacationer; and a search initiation widget 735, which may be implemented as an action button, which urges the booking system search engine (not shown) to search for and display vacation properties meeting the characteristics of the data entered by the prospective vacationer and to return a bracket-grid bearing property data records. For example, period matrix 800 may be provided (See FIG. 8), or seasonal matrix 900 may be provided (See FIG. 8), depending upon the data provided by the user in the widgets. As another example, by entering a check-in/check-out date in widgets 715, 720, a period matrix 800 can be presented to the user, whereas, by not entering a check-in/check-out date in widgets 715, 720, seasonal matrix 900 can be presented. The information provided in matrix 700 can be used with period grid in FIG. 8, Seasonal Grid in FIG. 9, or property grid in FIG. 10. Through the selection process by the user, the information selected can be property record in FIG. 11 may be representative of a vacation rental property desired by the user. However, property record in FIG. 11 provides the user with the capability of returning to the property grid in FIG. 11 or matrix 700 in FIG. 7.

In FIG. 8, period grid 805 may be represented as an interactive element of period matrix 800. Matrix 800 may have other interactive elements. In an embodiment, matrix 800 also may include data entry matrix 890 similar in form and function to vacation data entry matrix 700 in FIG. 7. Period grid 805 may have a horizontal header 810 and a vertical header 815. Header 810 can be composed of non-interactive graphical cells indicating the number of bedrooms, or the identities of the weeks preceding, including, and following the check in and check out date data entered in check-in widget 715 and check out widget 720 in FIG. 7. In a non-limiting example, “target” vacation date range 820 (here, November 21 to November 28) is bracketed to the left by similar period 825 (here November 7-November 14), and similar period 830 (here, November 14-November 21) preceding “target” vacation date range 820. Date 820 can be bracketed to the right by similar period 835 (here, November 28-December 5) and similar period 840 (here, December 5-December 12) following “target” vacation date range 820. Although periods 820, 825, 830, and 835 are illustrated as a week, other periods can be used, for example, three and one-half weeks. Down vertical header 815 is listed a bracketed number of bedrooms pertaining to the “target” number of bedrooms selected by bedroom widget 725. For example, if the prospective vacationer selected a two bedroom preference, one and three bedrooms also is shown. Had the prospective vacationer selected a five bedroom preference, four and six bedrooms also can be shown. Note that, in alternative embodiments, other features, including number of guests or lodgers, or bed size (e.g., “King,” or “Queen”) may be selectable in addition to or in substitution of the target number of beds in header 815.

Nested in the vertical and horizontal headers can be a coupled, interactive grid 805, composed of cells disposed in a grid-like arrangement. Each cell 845 of grid 805 includes property count record 850 and average rate record 855, as may be produced by record processor 610 in FIG. 6. In embodiments, average rate record 855 can be an average nightly rate record. Thus, at a glance, a prospective vacationer can see the average nightly rate for bedroom bracket 815, and period bracket 825, informing the vacationer not only of what the average rate and availability of occupancies are for the selected period and selected number of beds, but also of what the average rate and availability of occupancies for adjacent time periods and number of beds. A prospective traveler may be alerted to less expensive or more costly periods and number of beds. Upon mouseover of each cell, a “tooltip” showing the availability and average rate appears.

Period matrix 800 also can include filter features including, without limitation, location type filter 870, property type filter 872, filter by price 874, or a sort-by filter 876, which may be implemented as drop-down menus. Location type filter 870 enables a prospective vacationer to choose a vacation property by type of location, such as beach, downtown, golf, lake, mountain, near the ocean, skiing, waterfront, other, or any. Property type filter 872 enables a prospective vacationer to choose a vacation property by type of property, such as apartment, bed & breakfast, bungalow, cabin, campsite, castle, castle/mansion, chalet, chateau, condo, cottage, couch, divers, dorm, estate, farmhouse, finca, gite, house, hostel, holiday village, igloo, lodge, loft, lighthouse, manor, monastery, penthouse, resort, room, residence, studio, self-catering apartment, self-catering villa, timeshare, townhouse, treehouse, unit, villa, yacht/boat, other, or any. Filter-by-price 874 enables a prospective vacationer to choose a vacation property by average nightly rate price range, for example, $1-$99, $100-$199, $200-$299, $300-$399, $400-$499, $500+, or “any”. Sort-by filter 876 enables a prospective vacationer to choose a vacation property by distance, price: low to high, or price: high-to-low. Of course, all of the following examples may have substitutions of other entities.

Period matrix 800 also may include vacation rental selector 878, hotel selector 880, currency selector 882, list selector 884, map selector 886, or cities selector 888. From the period matrix 800, vacation rental selector 878 can advance the user to seasonal grid 900, which will be described more completely in FIG. 9. Hotel selector 880 can advance the user to a property matrix represented as a webpage featuring hotel rooms, similar in form to a property matrix of vacation rental properties, which will be described in FIG. 10. Currency selector 882 can be used to convert the displayed average nightly rate 855 to one of many rates, such as U.S. dollars, Australian dollars, British pounds, Canadian dollars, Euros, and Hong Kong dollars. Of course, other currencies may be added to currency selector 882. This tool 882 may be useful to international visitors seeking a vacation rental property. List selector 884 can be coupled to map selector 886. Map selector 886 may display properties associated with grid 805 in a geographical spatial arrangement (a map), color-coded to indicate average nightly rates. List selector 884 can return the view of properties back to a list arrangement.

Turning to FIG. 9, at least one embodiment of seasonal matrix 900, a coupled, color-coded, interactive grid 905 can be provided, containing a plurality of color-coded cells (generally at 910). Grid 905 can be configured to illustrate at least one vacation rental booking rate, such as an average nightly booking rate 911 for booking periods in a predetermined booking period, for example, an annual period and for a selected accommodation, for example, the number of bedrooms. The plurality of color-coded cells 910 can have a horizontal dimension 912 representative of a first characteristic, and a vertical dimension 914 representative of a second characteristic. The color-coding 915 of the coupled, color-coded, interactive cell 910 can be representative of a third characteristic. In a non-limiting example, a record displayed in the coupled, color-coded, interactive cell 910 can be an average rental booking rate 911 relative to preselected time period, such as per-night. The horizontal dimension 912 representative of a first characteristic can be time, in one example, displayed as continuous months bracketing a selected month of proposed vacation rental property occupancy, grouped by horizontal delimiters, here months. The vertical dimension 914 representative of a second characteristic can be an accommodation attribute grouped by vertical delimiters. An accommodation attribute 912 can be at least one of number of bedrooms in a vacation rental, a number of guests that can be lodged in the vacation rental unit, a bed type (e.g., king, queen, twin, etc.) available in a bedroom, or a combination thereof. The third characteristic color-coding 915 may be representative of a relatively low nightly booking rate, a relatively average nightly booking rate, and a relatively high nightly booking rate, all relative to the season and/or week for which the prospective vacationer seeks information. For example, in September 2015, which may be “off-season,” the average nightly booking rate can be relatively low, compared to other months, e.g., a one bedroom vacation rental can cost about $108 per night. The corresponding cell can be color coded for a selected “LOW” range. Continuing with the example, a one bedroom vacation rental in February 2016, which may be peak “season,” the average nightly booking rate can be relatively high, compared to other months, e.g., a one bedroom vacation rental can cost about $149 per night. The corresponding cell can be color coded for a selected “HIGH” range. In between the selected “LOW” range and the selected “HIGH” range can be a selected “AVERAGE” range, which may be determined, for example, by record processor 610 in FIG. 6 determining the low, mid-range and high average value, for example, from each record in vacation rental databases 625 in FIG. 6. In an embodiment, matrix 900 also may include data entry matrix 930 similar in form and function to vacation data entry matrix 700 in FIG. 7. In addition, matrix 900 can include vacation rental selector 978, hotel selector 980, currency selector 982, list selector 984, map selector 986, or cities selector 988. Each of the selectors 978, 980, 982, 984, 986, and 998 have similar functionality to selectors 878, 880, 882, 884, 886, and 898, respectively, as described with respect to FIG. 8. Further, matrix 900 also can include filter features including, without limitation, location type filter 970, property type filter 972, filter by price 974, or a sort-by filter 976, which may be implemented as drop-down menus. These are similar in function to filters 870, 872, 874, and 876 described with respect to FIG. 8.

FIG. 10 illustrates a vacation rental property matrix 1000 composed of the vacation rental property records, generally arranged in a grid at 1005, including pictorial representation of a selected number of vacation rental properties. Preferably each element 1010 of matrix 1000 has some pictorial representation, although that is not a requirement. Pictorial representation can be stored, retrieved, and displayed in the form of a record. Each matrix element generally includes a property location, property type, and an average nightly rental rate for the selected period. The pictorial matrix appearance allows a user to see properties at-a-glance, along with property booking rate, and rental unit size (e.g., number of bedrooms, baths, and number of potential lodgers).

In certain embodiments, such as seen in FIG. 10, webpage 1050 of the online vacation rental system, may include a coupled pairing of period matrix 800 and vacation rental property matrix 1000, or a coupled pairing of seasonal matrix 900 and vacation rental property matrix 1000. In certain embodiments, period matrix 800 or seasonal matrix 800 can be displayed in an upper portion of 1050 webpage, and vacation rental property matrix 1000 can be displayed in a lower portion of webpage 1050. Vacation rental property record 1005 displayed in property matrix 1000 can be coupled to the parameters selected for period matrix 800 or seasonal matrix 900. Also, webpage 1050 can include a vacation data entry matrix 1030 such as matrix 700 in FIG. 7. Further, webpage 1050 can have an interactive widget 1075, which permits a user to see more vacation rental properties than those shown on webpage 1050.

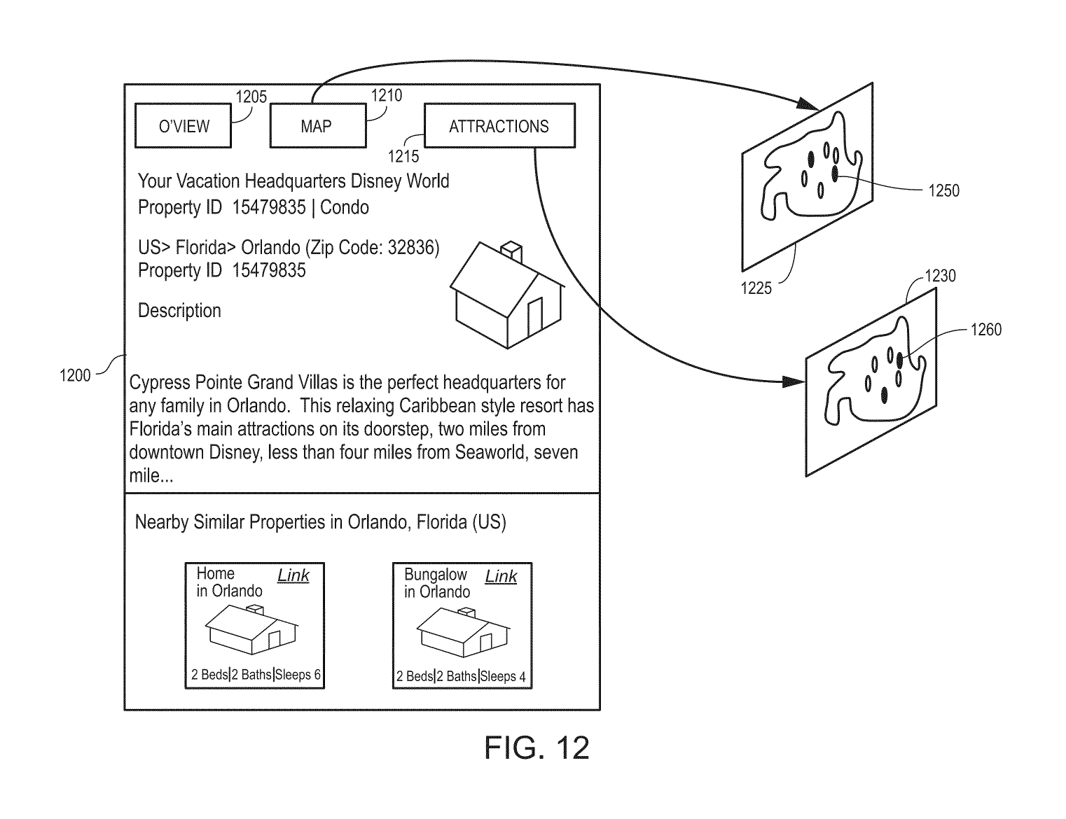

Vacation rental property record 1105, in FIG. 11, which can be similar to vacation rental property record 1005 in FIG. 10, can be coupled to vacation property identifier record 1100. Record 1100 can include title 1110 describing the record or property, geophysical location 1115, such as a postal zipcode, city, or both, property record number 1120, and property type 1125. A photographic representation 1127 of the property may be provided. Further, narrative 1130 can be included in record 1105. Narrative 1130 can be provided as a written description of the property qualities, as well as a written description having a list of amenities. Conveniently, a shorter listing of like properties 1135 may be displayed beneath record 1105 information, which may aid the user in finding a suitable vacation rental property. Page 1100 also may include overview widget 1140, map widget 1145, and attractions widget 1150. Page 1100 is depicted as in the overview (“o′view”) mode, with data and narrative displayed. Map and attractions widgets can be explained in FIG. 12.

FIG. 12 illustrates additional interactive capabilities which may be provided to vacation rental property record 1200, for example, overview widget 1205, geographic locator widget 1210, and attractions locator widget 1215. Record 1200 is similar to record 1100. When selected, geographic locator 1210 cause the display processor to show each of a selected number of vacation properties being indicated on map 1225 with color-coded icon 1250. The vacation property map 1225 can be made available by choosing a “MAP” selector (geographic locator widget 1210). Using MAP selector 1210, a prospective vacationer can tell at-a-glance where properties are spatially located relative to each other and relative to geographic features, such as a beach, a mountain, a street, a park, an interstate highway, and other places of interest depicted on map 1225. Color-coding, again, may be used to indicate a pricing range of the property. In particular, color-coding of the color-coded icons can be used to depict the price-per-night range of a vacation property. The prospective vacationer may be able to use the color-coded icons and geospatial location to decide where to select a vacation rental property relative to geographic features and nightly price range of a vacation rental property. Such map 1225 may be generated by way of GOOGLE® MAPS API, from GOOGLE®, Mountain View, Calif. USA, and available at https://developers.google.com/maps.

Yet further coupled to vacation rental property record 1200 can be attractions geographic locator widget 1215 which, when selected can produce attractions locator, or map 1230. Using map 1230, a prospective vacationer can tell at-a-glance where features are relative to the geographic region in which vacation rental properties of interest are located, each using color-coded icon 1260. Features can include, without limitation, entertainment, dining, and drinking locations, venues, and services. Such map 1230 may be generated by way of GOOGLE® PLACES API, from GOOGLE®, Mountain View, Calif. USA, and available at https://developers.google.com/places. Color-coding of icons can help the prospective vacationer, at a glance, differentiate from among different types of features, for example, a restaurant or a bar.

In yet other embodiments, an Online Vacation Rental Booking System can be adapted to operate in the mobile device milieu to produce a Mobile Online Vacation Rental Booking System. Mobile online vacation rental property booking can be especially useful to travelers who unexpectedly find themselves in a given location, particularly when the location is unfamiliar to them. A mobile online vacation rental booking system can include a mobile application having a selectable user interface coupled to a display of a mobile device. The selectable user interface configured to transmit first selected vacation data to the mobile device and receive second selected vacation data from the mobile device. Also included can be an aggregator search engine coupled to receive first selected vacation data from the mobile device and to transmit second selected vacation data to the mobile device. A plurality of remote partner databases can be coupled with the aggregator search engine to exchange the first selected vacation data for second selected vacation data. The aggregator search engine is configured to cause the second selected vacation data to be shown on the display of the mobile device. The first selected vacation data can be, without limitation, a geospatial location, accommodations, and price, and booking information. The second selected vacation data can be, without limitation, a vacation property record, which may include a price, a photo of the property, an accommodation, and a property record identifier, or one of a confirmation, a decline, or a “contact owner” comment.

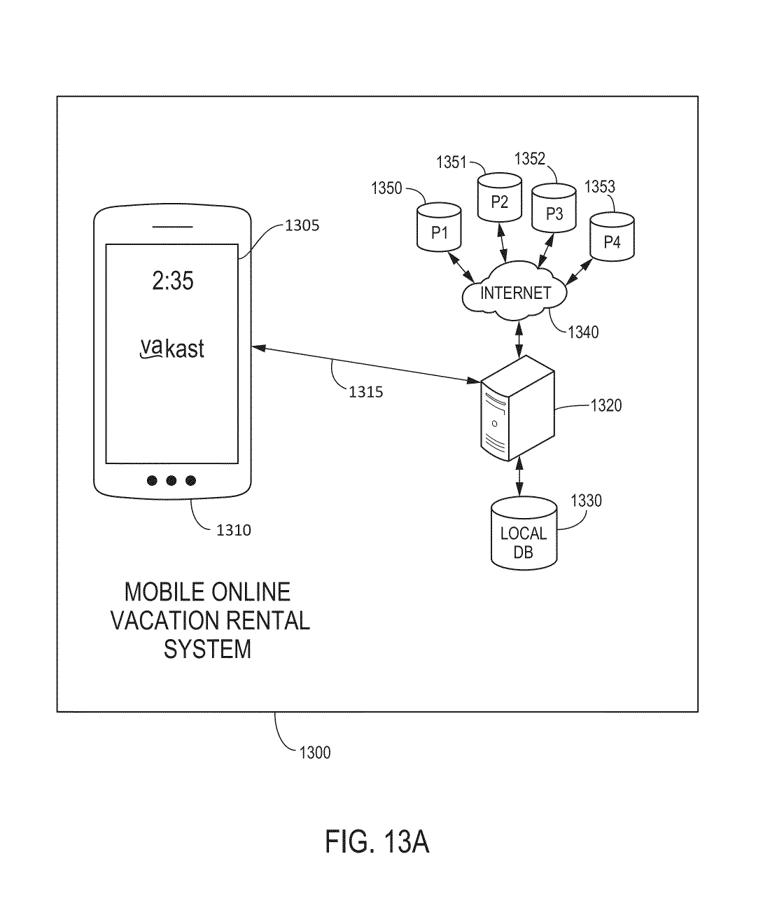

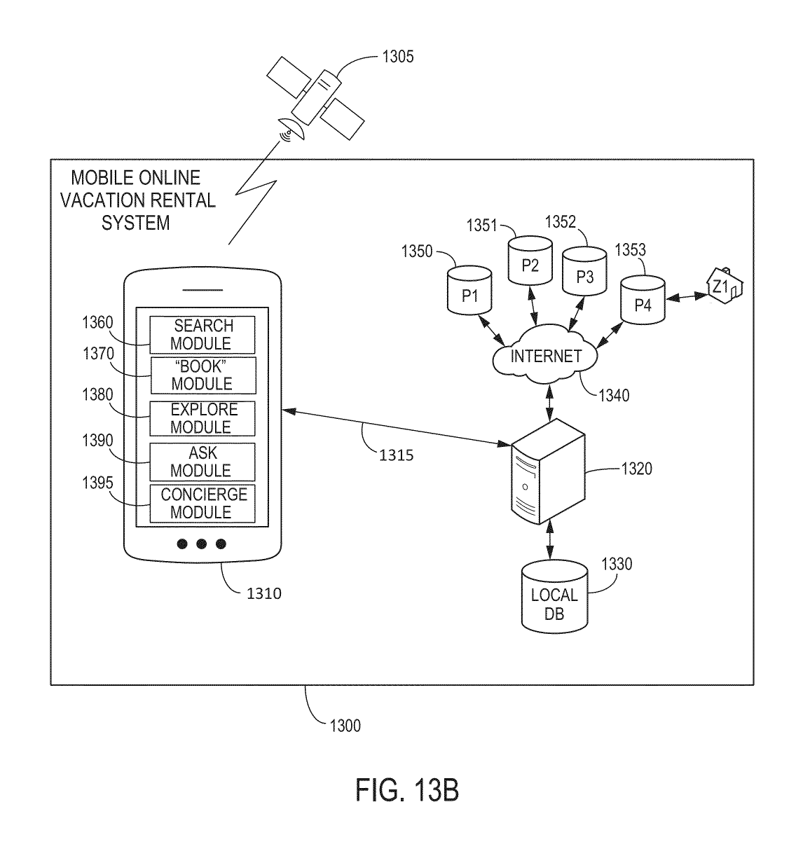

FIG. 13A illustrates a representation of an embodiment of mobile online vacation rental booking system 1300 including mobile device 1310, which can be coupled to server 1320 via wireless link 1315. Mobile device 1310 can be a mobile phone, mobile tablet, mobile laptop, or any mobile computing device which employs applications (apps) as user interfaces for a user to access a system. Server 1320 can be a software module on a computer, or could be part of a group of servers 1320 intended for use by system 1300. Wireless link 1315 can be representative of any wireless service, whether defined by an IEEE standard or by a mobile phone standard as provided, for example, by the ITU, ETSI, 3GPP, IETF, or other standards-making groups. Examples of wireless link 1315 include, without limitation, Bluetooth, IEEE 802.11, IEEE 802.15, IEEE 802.16, IEEE 802.20, GSM/GPRS/EDGE, CEMA/WCDMA/CDMA-2000, LTE, and TDMA/PDC. Use with GNSS systems (e.g., GPS) can be particularly useful to a traveler who wishes to stay at a “local” property. Many mobile devices include GPS services and make the geospatial data available to users both visually and through software applications (apps).

Mobile device 1310 can have display 1305 capable of displaying text, attribute data, and graphical information, directly or interactively. Mobile device display 1305 can have a selectable user interface having well-known behavior features capable of implementing touch gestures, including at least one of, without limitation, rotate, swipe, pinch, spread, single- or double-tap, flick, scroll, or drag-and-drop. Mobile device 1310 can receive second selected vacation data from server 1320 and display that data on display 1305.

Mobile device 1310 can host a portion of system 1300, which can include a SEARCH module, an EXPLORE module, a BOOKING module, an ASK module, a communication module, an administrative module, and other functional modules, as exemplified by mobile device 1310. Similarly, server 1320 can host a search engine, aggregator module, communication module, interface module, administrative module, and other functional modules, exemplified by server 1320. Server 1320 can be coupled to a local database 1330. Server 1320 also can be coupled to remote partner servers/databases (sites) 1350-1353 via Internet 1340. Partner sites 1350-1353 can contain attributes about vacation rental properties, nearby attractions, environmental features, and related geospatial data.

Server 1320 can be used to select attributes local to each selected vacation rental property, a nearby attraction, an environmental feature, and related geospatial data, from partner databases 1350-1353, or local database 1330, and present it to the user through interactive mobile device display 1305. Although system 1300 can be used to find data for locations remote from the immediate location of mobile device 1310, system 1300 can be used to find data for the geospatial region immediate to mobile device 1310.

Server 1320 may host a search aggregator module which may aggregate information from remote partner databases 1350-1353. A search aggregator module is a software module that runs on server 1320, and fetches, filters, and organizes a specific search from remote partner sites 1350-1353. It may store the aggregated data on local database 1330. Local database 1330 can host a plurality of databases, including a vacation property database, an attraction database, and an interactive map database, again, as described relative to FIG. 6. Local aggregation of data can assist the user with a quick response to queries from mobile device 1310, based on recent query responses, and can reduce the overall query load on remote partner databases 1350-1353. Search aggregation by server 1320 can help fetch, filter, and organize data specific to a particular search.

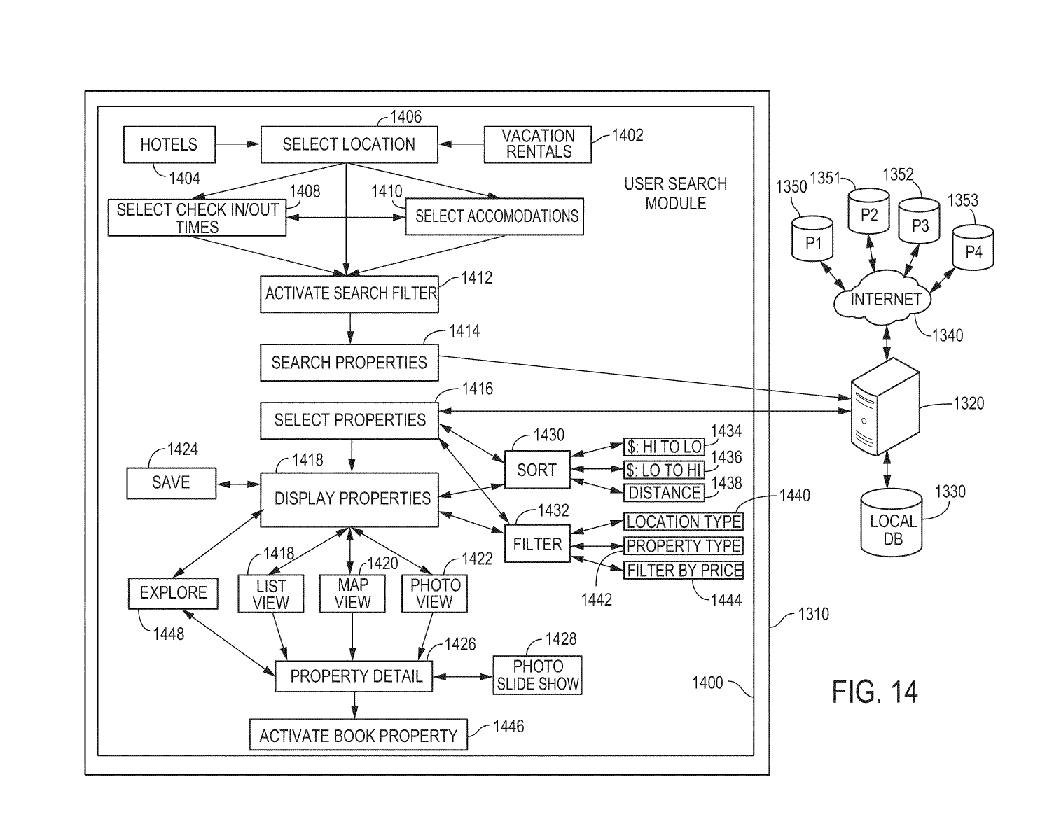

Partner databases 1350-1353 can host vacation rental data, attraction data, and map or geospatial data, as described with respect to FIG. 6. A partner site for attraction data can be a user accommodations and rating database such as YELP®, as described in FIG. 6, which can provide the user with information about an establishment within a preselected category. Also, GOOGLE® PLACES API, may be used to locate and provide information about attractions. Of course, other user attraction databases may be used. GOOGLE® MAPS may be used as described in FIG. 12. Partner databases 1350-1353 can host vacation rental data pertaining, for example, to a hotel, or to a vacation rental property, such as a bedroom, a studio, an apartment, a house, or a villa, in a vacation rental database Of course, there are myriad types of vacation rental properties available through partner sites 1350-1353, as described relative to FIG. 14. Some provide information about rental properties, some provide attraction details, some provide information and reservation services, and so on. Prior to providing a search request for a geospatial location, a user can select between a hotel property and a rental property. Both will be referred to a vacation rental property hereinafter. When commanded to do so by a search request on mobile device 1310, the search engine in server 1320 may place selected search requests with remote partner servers/databases 1350-1353.

In some embodiments, server 1320 may search 1330 for locally maintained data, for example, from previous searches, or from recent data aggregation. The search requests are shaped by data provided on display 1305 in predetermined parameters available on mobile device 1310. Properties matching the data provided in the predetermined parameters can be retrieved from partner databases 1350-1353 and sent back via server 1320 to mobile device 1310 and shown on display 1305. Local database 1330 may host all or a portion of the data retrieved from partner databases 1350-1353, if at all. The harvested data can be examined by a user (not shown), who may select from among the harvested data or who may initiate a new search. Predetermined parameters may be property related, or may be attraction related.

FIG. 13B illustrates widgets, or graphical control elements, that can activate modules, which may be employed on selectable user interface on display 1305 to operate mobile online vacation rental booking system 1300. Here, shown as rectangular buttons, widgets may be illustrated with any graphical element suggestive of the corresponding module. Example modules may select, for example, SEARCH module 1360, “BOOK” module 1370, EXPLORE module 1380, ASK module 1390, and a CONCIERGE module 1395. Each may be represented by a graphical widget on display 1305. Although shown vertically-oriented in FIG. 13B, such widgets also can be oriented horizontally. Here, shown as rectangular text buttons, selected widgets may be illustrated with any suggestive graphical element such as an icon. Selected widgets can be clustered into an always-on-top tool bar, which gives mobile device 1310 user extensive access to the functionality represented by the widgets. SEARCH module 1360, as depicted in FIG. 14, can be used to locate and identify vacation property rentals of interest. SEARCH module 1360 may be represented, without limitation, by a magnifying glass-styled icon. Module 1360 can be used in conjunction with GNSS systems 1305, such as GPS, to provide accurate information about vacation rental properties in the vicinity of the user's current location. A massive “effective” database provided by local database 1330 and partner databases 1350-1353, provide an extensive number of properties, for example, over one million, which the SEARCH module may filter to winnow the findings to relevant vacation property listings in a selected geospatial location. Extensive browsing is possible, using the SEARCH module 1360, for the user to find the right property on the right dates at the right price. “BOOK” module 1370 may select a user interface to be used to engage a vacation rental property, once it is identified, selected, and accepted by the user. Engaging/engagement means to secure for use, to hire, to employ, or to bind legally to provide a service. The user can be coupled with the selected vacation rental property and may make necessary communications with the property manager or owner regarding engaging the property for a vacation stay. A vacation rental property may be, but it not necessarily, a hotel. The location can be one selected in the SEARCH module, or may be another. A location may be remote, or local as determined via GNSS systems 1305.

EXPLORE module 1380 can be a handy tool for the traveler. EXPLORE module 1380 may be selected from a predetermined tool bar present on the display, or may be used from within the SEARCH module 1360 and “BOOK” module 1370, to identify many locations for goods or services that may be desired by the user, for example, a doctor, pharmacy, or supermarket closest to the selected property. The listed goods or services for a location are presented in interactive map form, relative to the location in which the selected property is located. Indeed, the EXPLORE module 1380 may prompt a user to select one property over another at a particular vacation rental property, because the selected property may be closer to, for example, retail shopping. The availability of the EXPLORE module enriches the user's vacation rental selection experience. ASK module 1390 can be useful for a user to contact the customer service personnel of the mobile online vacation rental system 1300 owner or operator, for example, if they are lost in the location near the vacation rental property, if the accommodation booking has a problem, or as feedback to the owner or operator of system 1300. CONCIERGE module 1395 may select a user interface to be able to engage services or make reservations through system 1300, a value-added feature of system 1300. Conveniently, CONCIERGE module 1395 allows a user “24/7” reservation services.

FIG. 14 depicts a flow diagram of a user search module 1400, similar to SEARCH module 1360, which may be used on mobile device 1310. In some embodiments, search module 1400 may have a user interface, or front end, similar in structure and function to vacation data entry matrix 700, seen in FIG. 7, which may be presented on display 1305. From a home screen, e.g., display 1305, a user may provide data for a preselected number of parameters. A user can select a vacation property category from vacation rentals 1402 or hotels 1404. Once a vacation property category is chosen, a user can select a vacation property location 1406. The user may choose to select a check in time and/or a check out time 1408. The user may choose to forgo selecting a check in/out time 1408 and may decide to select type of accommodations 1410. Type of accommodations 1410 can include the number of guests, the number of bedrooms desired, or the number of guests that can be accommodated at the vacation property. Type of accommodations 1410 also may be foregone. Typically the user will select location 1406, check in/out time 1408, and type of accommodations 1410. For example, a user may select Orlando, Fla. USA, with Oct. 2, 2015 check in and Oct. 9, 2015 check out, for 2 guests in a 1 bedroom vacation property. With this data entered, the user can activate the SEARCH filter 1412.

Activating the SEARCH filter 1412 can generate a search request 1414 to server 1320 from mobile device 1310. Server 1320 can select from among from partner databases 1350-1353. A selected number of partner databases 1350-1353 may be searched, for example, one, several, or all. Server 1320 also may check local database 1330 to see if the search request 1414 can be fulfilled from there. Properties are selected 1416 according to the data provided in the predetermined parameters. Selected properties 1416 may be sent to mobile device 1310. None, some, or all of the selected properties 1416 can be stored on mobile device 1310. Similarly, none, some, or all of the selected properties 1416 can be stored on local database 1330, with properties being sent to mobile device 1310 upon demand. Selected properties 1416 can be displayed on display 1305 of mobile device 1310 in a predetermined format, such as a 1×n grid (or vertical list), or an m×n grid, where m is the horizontal aspect of the display and n is the vertical aspect. Typically m<n.

Each property may be displayed on display 1035 with a property photo, an average nightly rent, number of bedrooms, and a number of guests accommodated, although other property attributes may be displayed. Selected properties 1416 may be sorted 1430 or filtered 1432. For example, sort 1430 may enable a user to sort the selected properties by price: high-to-low 1434, by price: low-to-high 1436, or by distance from the location selected in the search 1438. Of course, other sort 1430 parameters may be used. Filtering 1432 can be performed on location type 1440, vacation property type 1442, or price 1444. Again, other filter types may be implemented. As described with respect to FIG. 8, location type filter 1440 enables a prospective vacationer to choose a vacation property by type of location, such as beach, downtown, golf, lake, mountain, near the ocean, skiing, waterfront, other, or any. Property type filter 1442 enables a prospective vacationer to choose a vacation property by type of property, such as apartment, bed & breakfast, bungalow, cabin, campsite, castle, castle/mansion, chalet, chateau, condo, cottage, couch, divers, dorm, estate, farmhouse, finca, gite, house, hostel, holiday village, igloo, lodge, loft, lighthouse, manor, monastery, penthouse, resort, room, residence, studio, self-catering apartment, self-catering villa, timeshare, townhouse, treehouse, unit, villa, yacht/boat, other, or any. Filter-by-price 1444 enables a prospective vacationer to choose a vacation property by average nightly rate price range, for example, $1-$99, $100-$199, $200-$299, $300-$399, $400-$499, $500+, or “any”. Average nightly rate price range also may be filtered with a dynamic range. Of course, other filter parameters 1432 may be used.

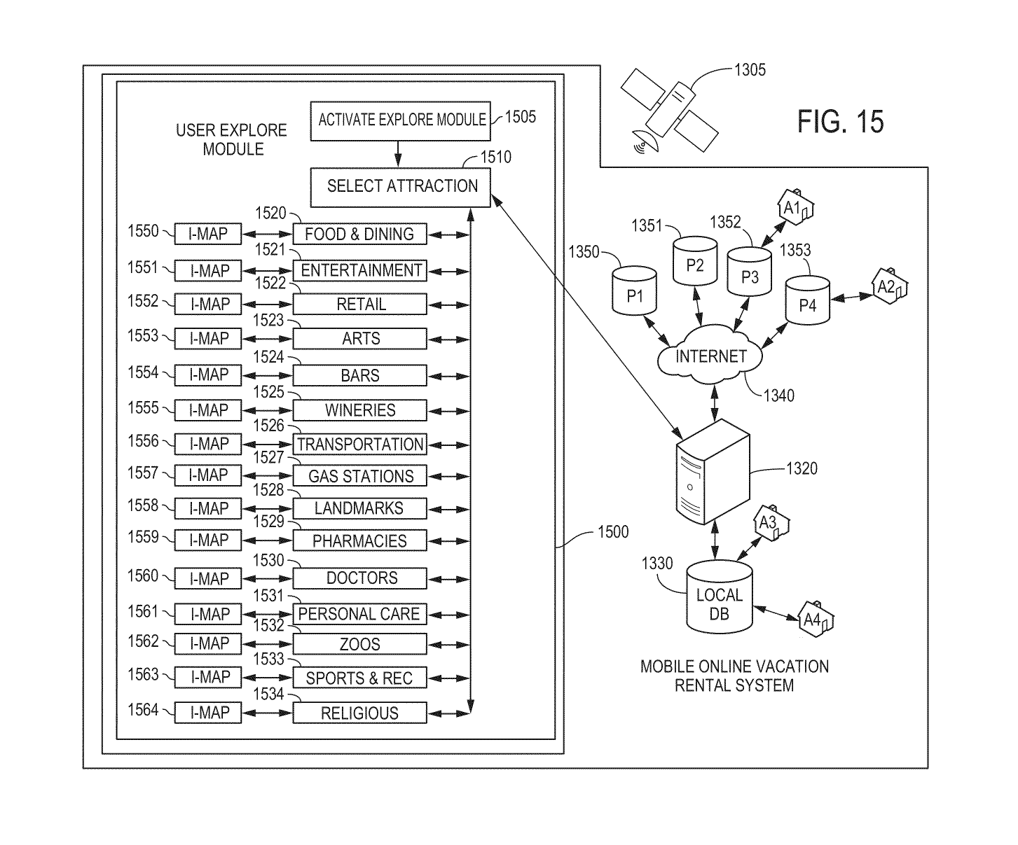

For each property in a location, a price, accommodations (e.g., a number of bedrooms, a number of guests which can be accommodated at the property) and, a hypertext link to the property detail record, may be displayed in one of several formats: LIST view 1418, MAP view 1420, or PHOTO view 1422, for example. Each format can be selected on mobile device 1310 by selecting an associated icon. Typically, the LIST view 1418 can be shown (e.g., in a 1×n grid). In LIST view 1418, plural vacation properties can be displayed at a time on display 1305 of mobile device 1310. The format can be similar to that shown in FIG. 10, except that it may be clearer to view if the record, such as 1010 in FIG. 10, are displayed as single line of vertically interactive “tiles,” although a grid display, such as generally at 1005, may be used. In MAP view 1420, a graphical representation of geographical location may be shown using an icon on the map to identify each vacation property, such as described with respect to FIG. 12. The icons may be mono-colored, or may be color-coded, for example, according to price or to accommodations. In PHOTO view 1422, one or more photographs of the vacation property may be available for display. If multiple photos are available for a given property, a serial presentation of the photos, or “slide show” may be presented, and may be repeated as long as the property is displayed. A “SAVE” function 1424 permits a user to save a vacation property record of interest, for example, by storing a corresponding hypertext link. Later, the user may retrieve the particular property record stored with SAVE. Whether at the function of DISPLAY PROPERTIES 1418 or at the function of PROPERTY DETAIL 1426, the EXPLORE module 1448 can be invoked. EXPLORE module 1448 will be described in FIG. 15, below.

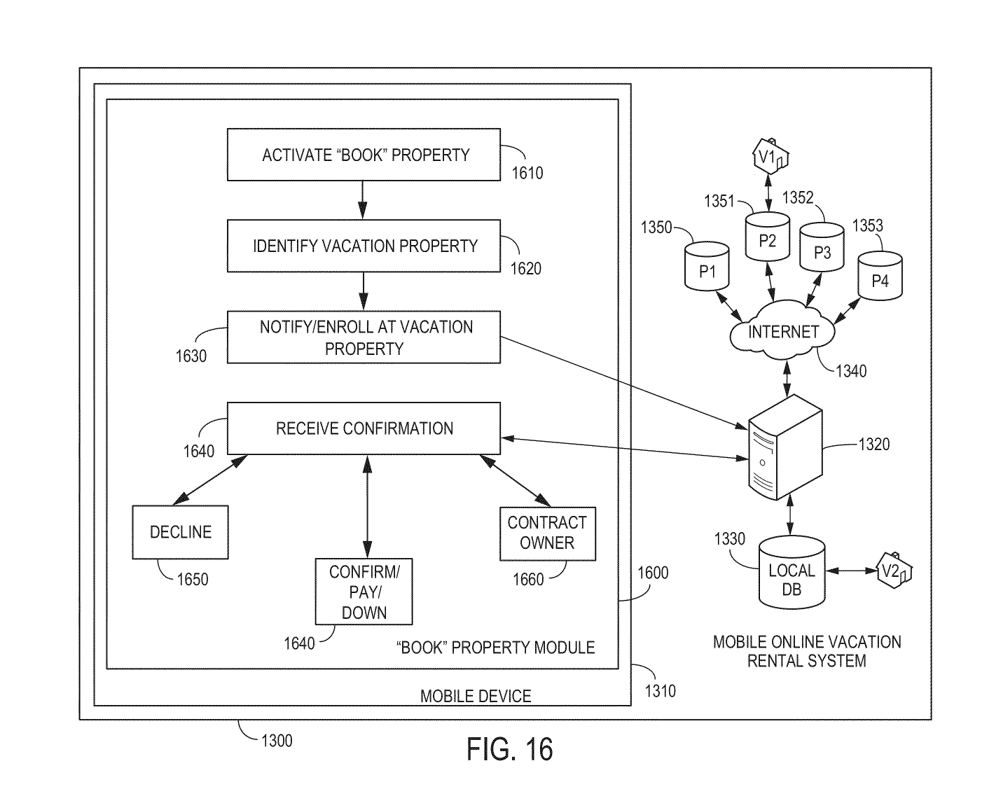

The hypertext link to the vacation property detail record, typically at the top of the vacation property record, can be linked to the vacation property detail record 1426, for example, as described with respect to FIG. 11. After reviewing the vacation property detail record 1426, a user may decide to rent the property featured in vacation property detail record 1426. In this instance, the user may activate a BOOK PROPERTY module 1446, which will described in FIG. 16, below.

Turning to FIG. 15, EXPLORE module 1500, similar to EXPLORE module 1380, is illustrated as being hosted on mobile device 1310. Generally, EXPLORE module 1500 gives a user of mobile device 1310 access to information about attractions in many categories. In some cases, a user may use EXPLORE module 1500 to make reservations for an attraction on a date of their vacation at a convenient time. EXPLORE module 1500 allows a user to find points of interest and necessary services, which may aid them in their decision to select a particular vacation rental property to book. After booking, EXPLORE module 1500 allows users to find points of interest and necessary services during their vacation at their chosen vacation rental property. Also, location can be set to “Current location” at any time, and the EXPLORE module 1500 can work with GNSS system 1305, to help the user identify an Attraction in the current location, which can be beneficial to a user traveling to or from their selected destination. To use the EXPLORE module 1500, the user can activate the EXPLORE module 1505, and select an attraction from among Categories of Attractions 1510.

Categories of Attractions may include Food & Dining 1520, Entertainment 1521, Retail 1522, Arts 1523, Bars 1524, Wineries 1525, Transportation 1526, Gas Stations 1527, Landmarks 1528, Pharmacies 1529, Doctors 1530, Personal Care 1531, Zoos 1532, Sports & Recreation 1533, and Religious 1534. Of course other categories of attractions may be accommodated, such as, without limitation, coffee shops (e.g., STARBUCKS®), fast food establishments (e.g., McDonald's®), banks, and home office services (e.g., FedEx Office®). Categories of Attractions 1520-1534 can be presented in EXPLORE module 1500 in a scrollable widget grid of m×n, where m is the horizontal aspect and n is the vertical aspect and, typically m<n. For example, each widget can include a representative icon to visually guide the user to the available categories.

Each category 1520-1534 can be coupled to an interactive map (IMAP) 1550-1564 of the area nearest the chosen vacation rental property or “local” to GNSS system 1305 indication. On each IMAP 1550-1564 are disposed icons pinpointing establishments of the selected category. Upon touching an icon, a name, an address, and, perhaps, a phone number of the selected icon may be shown. Also, in some embodiments, upon touching the icon, photos, hours of operations and ratings may be shown. For example, when arriving late at night close to the chosen vacation rental property, and finding the gasoline tank nearly empty, EXPLORE module 1500 can help a user navigate to the gas station nearest them. The user can select widget 1527 (Gas Stations) causing information about nearby gasoline stations to be displayed, whereby the user selects a particular gas station open for operation, so that the user can refuel and continue to the destination. In another example, at night, a traveling user may seek a Gas Station having diesel fuel along the way and use “Current Location” as the location. In conjunction with GNSS system 1305, the traveling user can find a gasoline station nearby to fill up, using the EXPLORE module, and continue on the way to the selected location. In some embodiments, a user may make an appointment or reservation with selected attractions. The appointment or reservation may be made through a partner server/database, such as with establishment A1 through partner site 1352, or establishment A2 through partner site 1353 (remote reservation). Similarly, an appointment or reservation may be made through the local server/database (1320/1330). For an appointment can be made with establishment A3 or a reservation can be made with establishment A4 through local server/database (1320/1330) (e.g., local reservation).

In FIG. 16, a “BOOK” module 1600 is described, similar to BOOK module 1370, in FIG. 13B. To “book” or “booking” a property is to engage the property for use at a selected time following the booking. A user can begin by activating the “BOOK” property module 1610. Booking a vacation property includes identifying a vacation property 1620, for example, using the SEARCH module 1400. This may include obtaining a property code from a vacation property rental record, such as shown in FIG. 11. With the property identifier retrieved, local server 1320 can identify the partner site/database 1351, which is associated with remote vacation rental property, such as V1. The vacation rental property, here, V1, can be notified 1630 of the vacation property selection of the user, the check in/out dates requested, and the price advertised for the visit (together, booking information). A payment may or may not be provided by the user, at this stage. In turn, confirmation 1640 is received. The vacation rental property, V1, may confirm the reservation pending payment, and may accept down payment or a full payment at this time from the user, for example, by credit card, wire transfer, third party payment system, or some other mode of funds transfer. In an embodiment, V2, associated with local server/database 1320/1330, can be provided with booking information. This type of “local” booking may proceed as with V1. In some embodiments, a user may need to register with V1 at the booking stage 1630, in which the user may be asked to supply dates of engagement and, perhaps, a credit card number by which the vacation rental property can be reserved. In one alternative, V1 may decline 1650 the confirmation of the user, for example, due to an intervening booking, or declined credit card. In another alternative, the user may be asked to contact 1660 the owner of the vacation rental property, for example, for in-person screening or to complete the reservation in-person.

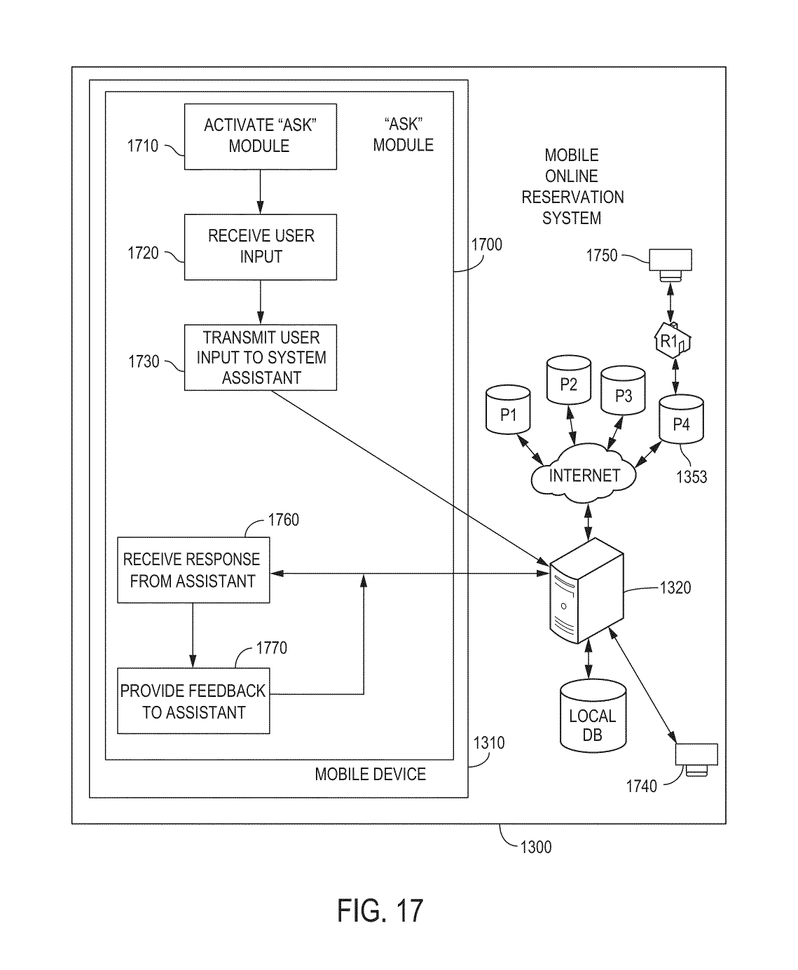

FIG. 17 illustrates an “ASK” module 1700, which allows a user to contact an assistance response mechanism on system 1300, such as, without limitation, HELP desk personnel or a voice actuated natural language response module. A user may activate the “ASK” module 1710 by touching the “ASK” widget on the display. The “ASK” widget may be available on a top-level toolbar, which contains widgets for always available services, such as SEARCH, and EXPLORE. On the mobile device, a user can activate the ASK module 1710 to allow module 1700 to receive user input 1720. This input may be in the form of a query such as a written question or statement, as for an e-mail, or a voice query, as for an automated natural language response system. The user input can be transmitted to a system assistant 1730, which receives the query and provides the query to server 1320, for dispatch to the proper response mechanism 1740. A response mechanism 1740 can be a trained human service assistant, a help service database, an automated voice-activated natural language response service, etc. Once response mechanism has selected a proper response relative to the user's query, the user receives a response from the assistant 1760. The response may lead to feedback to the assistant 1770, which may be in the form of additional queries, and which may be answered by one or more system response mechanism 1740.

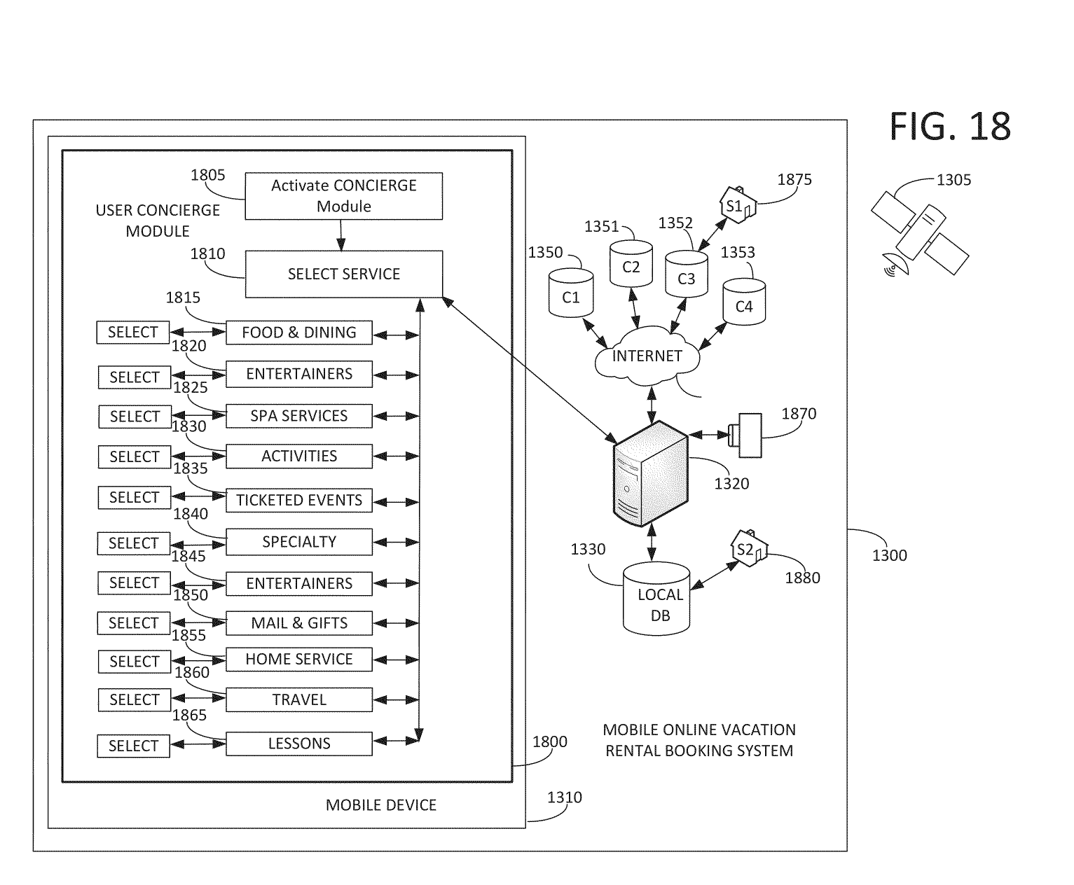

FIG. 18 illustrates a “CONCIERGE” module 1800, which provides the user with the functions to make a reservation or engage services from mobile device 1310. CONCIERGE can be a value-added or subscription service including paid services. CONCIERGE categories may include, without limitation, a Food & Drink Category 1815, a Spa Services Category 1825, an Activities Category 1830, a Ticketed Events Category 1835, a Specialty Category 1840, an Entertainers Category 1820, a Mail & Gifts Category 1850, a Home Service Category 1855, a Travel Category 1860, and a Lessons Category 1865. Of course, other categories may be used, added, or modified.

In the Food & Drink category 1815, listed services engaged may include Restaurant & Bar Recommendations, Restaurant Reservations, Grocery Shopping and Delivery, Personal or Specialized Chefs, Wine Tasting, and Catering. In the Spa Services category 1825, listed services such as Nails, Hair, Waxing, or Eyebrows, and Massage may be reserved. In the Activities category 1830, the system may provide reservation services for listed activities like Shopping, Tours, Museums, Golf, Surfing, Skydiving, Sailing, Scuba Diving, Snorkeling, Parasailing, Shark Diving, Zip Lining, and Gambling. In the Ticketed Events category 1835, engaged listed services may include arrangements for Comedy Clubs, Movie Tickets, Theater Tickets, Concerts, Sporting Events, Museums, and Nightclubs. In the Specialty category 1840, engaged listed services may include arrangements for Fitness Center, Fitness Trainer, Photographer, Florist, Babysitting or Nanny, Pet sitting, Pet Walker, or Pet Trainer, Eldercare, and Car Wash. In the Entertainers category 1820, engaged listed services may include Bands, Dancers, Karaoke, Magic, Clowns, and Miscellaneous entertainment. In the Mail & Gifts category 1850 listed services may be reserved such as Mail Service, Messenger or Courier, Gift Purchasing or Gift Mailing, Thank You Cards, and VAKAST™ Concierge Gift Certificate. In the Home Service category 1855, listed services which may be engaged include services such as House Keeping, Maid, Butler, and Driver. In the Travel category 1860, engaged listed services may include Vacation Rental, Hotel, Private Jet Charter Service, Airline Tickets, Taxi, Car Rental, Limousine Service, Town Car, or Shuttle Service. In the Lessons category 1865, reservations may be made for listed activities such as Yoga, Dance, Swimming, Tennis, Cooking, and Miscellaneous Lessons.

To engage a listed activity or a listed service, a user need only activate 1805 CONCIERGE module 1800 on mobile device 1310 at any day or at any time, select the service category 1810 and select the one of the listed services available (above). For example, S1 may represent a listed activity, such as a selected Comedy Club event available through the Ticketed Events category 1835. The user may select Comedy Club S1 and may reserve a ticket through System intermediary service 1870 automated ticket reservation system. Similarly, a user may select a service category 1810, for example, a listed service such as a private jet charter service S2 in Travel category 1860, which may be coupled to local database 1330. The user may book a reservation with the listed service to enable the users' entourage to fly to a selected vacation or meeting location. System intermediary service 1870 may be a module operating on server 1320 that also may serve to queue and place reservations initially requested by the user, but not able to be fulfilled by S1 or S2 due to, for example, time of day. When S1 or S2 is available, system intermediary service 1870 engages the listed activity by placing a reservation for the listed activity (S1) or engages the listed service (S2) on behalf of the user/customer. CONCIERGE also can be used to fulfill an inquiry sent by a CONCIERGE customer.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. A mobile online vacation rental booking system, comprising:
a mobile application having a selectable user interface coupled to a display of a mobile device, the selectable user interface configured to transmit first selected vacation data to the mobile device and receive second selected vacation data from the mobile device;
an aggregator search engine coupled to receive first selected vacation data from the mobile device and to transmit second selected vacation data to the mobile device;
a plurality of remote partner databases coupled with the aggregator search engine to exchange the first selected vacation data for second selected vacation data; and
the aggregator search engine being configured to cause the second selected vacation data to be shown on the display.

2. The system of claim 1, wherein the selectable user interface includes a SEARCH module and one of the plurality of remote partner databases includes a vacation rental database.

3. The system of claim 1, wherein the selectable user interface includes an EXPLORE module and one of the plurality of remote partner databases includes an attraction database.

4. The system of claim 2, wherein:
the first selected vacation data comprises a location for a selected vacation rental property, and the second selected vacation data comprises a record corresponding to the selected vacation rental property.

5. The system of claim 4, wherein the first selected vacation data further comprises check in/out time, accommodation, or both.

6. The system of claim 3, wherein:
the first selected vacation data includes one of categories of attractions and the second selected vacation data comprises a selected attraction having second selected attributes and an interactive map relative to a geospatial location.

7. The system of claim 5, wherein:
the selectable user interface is selected to include an EXPLORE module, the first selected vacation data is changed to one of categories of attraction and the second selected vacation data is changed to selected attractions having second selected attributes and an interactive map relative to a geospatial location.

8. The system of claim 1, wherein the aggregator search engine is wirelessly coupled to receive first selected vacation data from the mobile device.

9. The system of claim 1, wherein:
the selectable user interface is selected to include a BOOK module coupled to a vacation rental property of one of a plurality of remote partner databases, the first selected vacation data comprises booking information for the vacation rental property and the second selected vacation data comprises one of a confirmation of booking a specific vacation rental property of a geospatial location, or a decline, or a “contact owner” message.

10. The system of claim 8, wherein wirelessly couple comprises one of Bluetooth®, IEEE 802.11, IEEE 802.15, IEEE 802.16, IEEE 802.20, GSM/GPRS/EDGE, LTE, CEMA/WCDMA/CDMA-2000, or TDMA/PDC.

11. A method of booking an online vacation rental, comprising:
with a mobile device:
selecting a geospatial region;
accessing a plurality of partner databases with the mobile device to find a vacation rental properties at the geospatial region;
identifying vacation rental properties proximate to a selected geospatial location in the geospatial region, generating identified vacation rental properties;
exploring attractions proximate to the identified vacation rental properties;
displaying a property detail of the identified vacation rental properties; and
selecting one of the vacation rental properties based on an attraction or the property detail or both.

12. The method of claim 11, further comprising:
selecting between a hotel or a property rental before selecting a geospatial location.

13. The method of claim 11, further comprising:
after selecting the one of the vacation rental properties, booking the selected vacation property with the mobile device;
placing a deposit on the one of the vacation rental properties with the mobile device; and
receiving a confirmation or a decline from the vacation property manager to the mobile device.

14. The method of claim 11, further comprising:
prior to displaying the property detail with the mobile device, sorting the identified vacation rental properties according to price or distance.

15. The method of claim 11, further comprising:
prior to displaying the property detail with the mobile device, filtering the identified vacation rental properties according to location type, property type, or price.

16. The method of claim 11, further comprising:
activating a CONCIERGE module;
selecting a service category in the CONCIERGE module; and
engaging a listed service or a listed activity corresponding to the service category, or fulfilling an inquiry.

17. A mobile online vacation rental booking system, comprising:
a selectable user interface including a BOOK module coupled to a display of a mobile device, the selectable user interface on the display configured to transmit first selected vacation data to and receive second selected vacation data from the mobile device;
an aggregator search engine wirelessly coupled to the mobile device, the aggregator search engine configured to receive first selected vacation data from and transmit second selected vacation data to the mobile device; and
one of a plurality of remote partner databases coupled with the aggregator search engine, the one configured to receive first selected vacation data from and to transmit second selected vacation data to the aggregator search engine, the one further configured to book a selected vacation rental property associated with the one upon receiving booking information as the first selected vacation data and to transmit one of a confirmation of a specific rental at a geospatial location, or a decline, or a “contact owner” message as second selected vacation data.

18. The system of claim 17, further comprising:
a selectable user interface including an ASK module coupled to a display of a mobile device;
an aggregator search engine wirelessly coupled to the mobile device, the aggregator search engine configured to receive a selected query from and transmit a corresponding response to the mobile device; and
a response mechanism configured to produce the corresponding response in response to the selected query.

19. The system of claim 17, further comprising:
a selectable user interface including a CONCIERGE module coupled to a display of a mobile device, the selectable user interface on the display configured to transmit first selected vacation data to and receive second selected vacation data from a system intermediary, wherein the first selected vacation data is a reservation or an engagement of a service and the second selected vacation data is a confirmation of the reservation or the engagement.

20. The system of claim 17, further comprising:
a selectable user interface including an EXPLORE module coupled to a display of a mobile device, the selectable user interface on the display configured to transmit first selected vacation data to and receive second selected vacation data, wherein the first selected vacation data includes a selected category of attraction and a selected attraction and the second selected vacation data includes an interactive map corresponding the selected attraction.
